(19) United States
(12) Patent Application Publication
(10) Pub. No.: US 2026/0191225 A1
(43) Pub. Date: Jul. 9, 2026

(54) Drink Maker with Clog-Resistant Dispenser

(71) Applicant: SharkNinja Operating LLC, Needham, MA (US)

(72) Inventors: Macrae Benziger, Dedham, MA (US); Michael Lerman, Providence, RI (US)

(21) Appl. No.: 19/013,682

(22) Filed: Jan. 8, 2025

(51) Int. Cl. A23G 9/28

(52) U.S. Cl. CPC A23G 9/281

(57) ABSTRACT

A drink maker is provided with a clog-resistant dispenser. The drink maker includes a mixing vessel, a spout, a grate, and a dispenser assembly. The mixing vessel is configured to contain a drink product. The spout includes an opening in the mixing vessel. The grate is configured to at least partly cover the spout. The dispenser assembly includes a seal and a plurality of protruding members. The seal is configured to close a flow from the spout in a closed position and open the flow from the spout in an open position. The plurality of protruding members extend from the seal and at least partially extend into the spout through the grate when the seal is in a closed position.

### BACKGROUND

### 1. Technical Field

The present disclosure relates generally to drink makers and, in some non-limiting embodiments or aspects, to a drink maker with a clog-resistant dispenser.

### 2. Technical Considerations

Frozen drink makers, which also may be referred to as semi-frozen beverage makers or crushed-ice drink makers, may include a tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product may be dispensed through a tap, spigot, or dispenser. Thus, the term “frozen drink maker” as used herein, is not limited to a device that only makes drinks or frozen drinks, but includes devices that cool received drink products to produce cooled outputs in any of a variety of cooled, frozen, and semi-frozen forms. A drink product may consist of a liquid mixture, including water, juice, or milk, and may include additives, such as sugar, spirit, syrup, or flavoring powders, that give the drink product the desired taste and/or color. Frozen drink makers may include a mixing system within the mixing vessel, and further may include a refrigeration system to cool the drink product in the mixing vessel.

Frozen drink makers may encounter difficulties with dispensing cooled drink products, such as drink product that is frozen, partially frozen, and/or high viscosity. For example, such drink product may become lodged in or about a dispensing spout of the drink maker such that merely opening or closing a cover for the spout does not readily release the drink product. There is a need in the art for a technical solution to reduce clogging in the dispenser assembly of a drink maker.

### SUMMARY

Accordingly, provided is an improved drink maker with a clog-resistant dispenser.

According to some non-limiting embodiments or aspects, provided is a drink maker including a mixing vessel, a spout, a grate, and a dispenser assembly. The mixing vessel is configured to contain a drink product. The spout includes an opening in the mixing vessel. The grate is configured to at least partly cover the spout. The dispenser assembly includes a seal configured to close a flow from the spout in a closed position and open the flow from the spout in an open position. The dispenser assembly also includes a plurality of protruding members extending from the seal, the plurality of protruding members at least partially extending into the spout through the grate when the seal is in a closed position.

In some non-limiting embodiments or aspects, the seal and the plurality of protruding members may be formed coextensively from a same material.

In some non-limiting embodiments or aspects, the plurality of protruding members may be attached to a surface of the seal facing the spout.

In some non-limiting embodiments or aspects, the plurality of protruding members may define a plurality of recesses including at least one negative space adjacent the plurality of protruding members.

In some non-limiting embodiments or aspects, a geometry of the plurality of recesses may correspond to a geometry of the grate.

In some non-limiting embodiments or aspects, the grate may be at least partially received in the plurality of recesses when the seal is in the closed position.

In some non-limiting embodiments or aspects, each protruding member of the plurality of protruding members may be oblong in shape.

In some non-limiting embodiments or aspects, the grate may include a plurality of openings that are oblong in shape.

In some non-limiting embodiments or aspects, the plurality of protruding members may at least partially extend into the openings of the grate when the seal is in the closed position.

In some non-limiting embodiments or aspects, the plurality of protruding members may include at least four protruding members. The openings of the grate may include at least four openings. Each protruding member of the plurality of protruding members may correspond to an opening of the grate.

According to some non-limiting embodiments or aspects, provided is a dispenser assembly for a drink maker. The dispenser assembly includes a seal configured to close a flow from a spout of the drink maker in a closed position and open the flow from the spout in an open position. The spout includes an opening in a mixing vessel of the drink maker that is configured to contain a drink product. The dispenser assembly also includes a plurality of protruding members extending from the seal, the plurality of protruding members at least partially extending into the spout through a grate of the drink maker when the seal is in a closed position. The grate is configured to at least partly cover the spout.

In some non-limiting embodiments or aspects, the seal and the plurality of protruding members may be formed coextensively from a same material.

In some non-limiting embodiments or aspects, the plurality of protruding members may be attached to a surface of the seal facing the spout.

In some non-limiting embodiments or aspects, the plurality of protruding members may define a plurality of recesses including at least one negative space adjacent the plurality of protruding members.

In some non-limiting embodiments or aspects, a geometry of the plurality of recesses may correspond to a geometry of the grate.

In some non-limiting embodiments or aspects, the grate may be at least partially received in the plurality of recesses when the seal is in the closed position.

In some non-limiting embodiments or aspects, each protruding member of the plurality of protruding members may be oblong in shape.

In some non-limiting embodiments or aspects, the plurality of protruding members may at least partially extend into oblong openings of the grate when the seal is in the closed position.

In some non-limiting embodiments or aspects, the plurality of protruding members may include at least four protruding members.

In some non-limiting embodiments or aspects, each protruding member of the plurality of protruding members may correspond to an opening of the grate.

Further non-limiting embodiments or aspects are set forth in the following numbered clauses:

Clause 1: A drink maker comprising: a mixing vessel configured to contain a drink product; a spout comprising an opening in the mixing vessel; a grate configured to at least partly cover the spout; and a dispenser assembly comprising: a seal configured to close a flow from the spout in a closed position and open the flow from the spout in an open position; and a plurality of protruding members extending from the seal, the plurality of protruding members at least partially extending into the spout through the grate when the seal is in a closed position.

Clause 2: The drink maker of clause 1, wherein the seal and the plurality of protruding members are formed coextensively from a same material.

Clause 3: The drink maker of clause 1 or clause 2, wherein the plurality of protruding members are attached to a surface of the seal facing the spout.

Clause 4: The drink maker of any of clauses 1-3, wherein the plurality of protruding members define a plurality of recesses comprising at least one negative space adjacent the plurality of protruding members.

Clause 5: The drink maker of any of clauses 1-4, wherein a geometry of the plurality of recesses corresponds to a geometry of the grate.

Clause 6: The drink maker of any of clauses 1-5, wherein the grate is at least partially received in the plurality of recesses when the seal is in the closed position.

Clause 7: The drink maker of any of clauses 1-6, wherein each protruding member of the plurality of protruding members is oblong in shape.

Clause 8: The drink maker of any of clauses 1-7, wherein the grate comprises a plurality of openings that are oblong in shape.

Clause 9: The drink maker of any of clauses 1-8, wherein the plurality of protruding members at least partially extend into the openings of the grate when the seal is in the closed position.

Clause 10: The drink maker of any of clauses 1-9, wherein the plurality of protruding members comprise at least four protruding members, wherein the openings of the grate comprise at least four openings, and wherein each protruding member of the plurality of protruding members corresponds to an opening of the grate.

Clause 11: A dispenser assembly for a drink maker, the dispenser assembly comprising: a seal configured to close a flow from a spout of the drink maker in a closed position and open the flow from the spout in an open position, the spout comprising an opening in a mixing vessel of the drink maker that is configured to contain a drink product; and a plurality of protruding members extending from the seal, the plurality of protruding members at least partially extending into the spout through a grate of the drink maker when the seal is in a closed position, the grate configured to at least partly cover the spout.

Clause 12: The dispenser assembly of clause 11, wherein the seal and the plurality of protruding members are formed coextensively from a same material.

Clause 13: The dispenser assembly of clause 11 or clause 12, wherein the plurality of protruding members are attached to a surface of the seal facing the spout.

Clause 14: The dispenser assembly of any of clauses 11-13, wherein the plurality of protruding members define a plurality of recesses comprising at least one negative space adjacent the plurality of protruding members.

Clause 15: The dispenser assembly of any of clauses 11-14, wherein a geometry of the plurality of recesses corresponds to a geometry of the grate.

Clause 16: The dispenser assembly of any of clauses 11-15, wherein the grate is at least partially received in the plurality of recesses when the seal is in the closed position.

Clause 17: The dispenser assembly of any of clauses 11-16, wherein each protruding member of the plurality of protruding members is oblong in shape.

Clause 18: The dispenser assembly of any of clauses 11-17, wherein the plurality of protruding members at least partially extend into oblong openings of the grate when the seal is in the closed position.

Clause 19: The dispenser assembly of any of clauses 11-18, wherein the plurality of protruding members comprise at least four protruding members.

Clause 20: The dispenser assembly of any of clauses 11-19, wherein each protruding member of the plurality of protruding members corresponds to an opening of the grate.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Reference to the detailed description, combined with the following figures, will make the disclosure more fully understood, wherein:

FIG. 1 is a perspective view of a drink maker, according to some non-limiting embodiments or aspects;

FIG. 2 is a view of various internal components within the housing and mixing vessel of the drink maker of FIG. 1, according to some non-limiting embodiments or aspects;

FIG. 3 is a front view of the drink maker of FIG. 1, according to some non-limiting embodiments or aspects;

FIG. 4 is a schematic diagram of a control system of a drink maker, according to some non-limiting embodiments or aspects;

FIG. 5A is a side view of the drink maker of FIG. 1 with the mixing vessel in a coupled position relative to the upper housing section, according to some non-limiting embodiments or aspects;

FIG. 5B is a side view of the drink maker illustrated in FIG. 5A with some features of the housing and the lever shown in partial cross-section, according to some non-limiting embodiments or aspects;

FIG. 6 is a detailed view of a lever with cams for coupling a mixing vessel to the housing of a drink maker, according to some non-limiting embodiments or aspects;

FIG. 7A is a rear view of a mixing vessel, according to some non-limiting embodiments or aspects;

FIG. 7B is a perspective view of the rear of a mixing vessel, according to some non-limiting embodiments or aspects;

FIG. 8 is a perspective view of a flexible seal, according to some non-limiting embodiments or aspects;

FIG. 9 is a cross-sectional view of a flexible seal, according to some non-limiting embodiments or aspects;

FIG. 10 is a flow diagram for a method of using the disclosed drink maker, according to some non-limiting embodiments or aspects;

FIG. 11A is a perspective view of a condensation collection tray of the drink maker of FIG. 1, according to some non-limiting embodiments or aspects;

FIG. 11B is a perspective view of a condensation collection tray of the drink maker of FIG. 1, according to some non-limiting embodiments or aspects;

FIG. 11C is the condensation collection tray of FIGS. 11A and 11B inserted into the drink maker of FIG. 1, according to some non-limiting embodiments or aspects;

FIG. 11D is the drink maker of FIG. 1 with the condensation collection tray removed, according to some non-limiting embodiments or aspects;

FIG. 12 is a flow diagram illustrating a method of removing the condensation collection tray of FIGS. 11A and 11B from the drink maker of FIG. 1, according to some non-limiting embodiments or aspects;

FIG. 13A is an isometric view of the drink maker with a mixing vessel having at least one internal baffle, according to some non-limiting embodiments or aspects;

FIG. 13B is a cross-sectional view of the drink maker shown in FIG. 13A, taken along line B-B, according to some non-limiting embodiments or aspects;

FIG. 13C is a cross-sectional view of the drink maker shown in FIG. 13A, taken along line C-C, according to some non-limiting embodiments or aspects;

FIG. 14A is a rear isometric view of a mixing vessel for a drink maker with three internal baffles, according to some non-limiting embodiments or aspects;

FIG. 14B is a rear view of the mixing vessel shown in FIG. 14A, according to some non-limiting embodiments or aspects;

FIG. 14C is a front isometric view of the mixing vessel shown in FIG. 14A, according to some non-limiting embodiments or aspects;

FIG. 15 is a close-up view of a user interface, according to some non-limiting embodiments or aspects;

FIG. 16 is a graph of coarse and fine temperature settings, according to some non-limiting embodiments or aspects;

FIG. 17 is a close-up view of a user interface, according to some non-limiting embodiments or aspects;

FIG. 18 is a graph of temperature values associated with automatic temperature target temperature settings and manual temperature adjustments, according to some non-limiting embodiments or aspects;

FIG. 19 is a graph of drive motor current and temperature vs. time as a drink product being processed by the drink maker of FIG. 1, according to some non-limiting embodiments or aspects;

FIG. 20 is a flow diagram of a process for making a cooled drink product using a food type for initial or coarse temperature and/or texture control and then using a user input to subsequently fine tune the temperature and/or texture of the drink product, according to some non-limiting embodiments or aspects;

FIG. 21 is a flow diagram of a process for automatically detecting when drive motor current is too high and/or a drink product is too thick and, in response, adjusting the temperature of the drink product to reduce drive motor current and/or to increase the temperature of the drink product to reduce a thickness of the drink product, according to some non-limiting embodiments or aspects;

FIG. 22A is a view of a dual-use cooling fan within the housing of a drink maker, according to some non-limiting embodiments or aspects;

FIG. 22B is a view of a dual-use cooling fan within the housing of a drink maker, according to some non-limiting embodiments or aspects;

FIG. 22C is a perspective view of the dual-use cooling fan of FIG. 22B, according to some non-limiting embodiments or aspects;

FIG. 23 is a flow diagram of a process for operating the dual-use cooling fan, according to some non-limiting embodiments or aspects;

FIG. 24A is a perspective view of a sample pour-in opening for a drink maker, according to some non-limiting embodiments or aspects;

FIG. 24B is a front view of the pour-in opening shown in FIG. 24A, according to some non-limiting embodiments or aspects;

FIG. 24C is a left perspective view of the pour-in opening shown in FIG. 24A, according to some non-limiting embodiments or aspects;

FIG. 25 is a perspective view of a sample cover for a pour-in opening, according to some non-limiting embodiments or aspects;

FIG. 26 is a perspective view of a sample pour-in opening, according to some non-limiting embodiments or aspects;

FIG. 27A is a perspective view of a sample pour-in opening, according to some non-limiting embodiments or aspects;

FIG. 27B is an isometric view of a pour-in opening of FIG. 27A, according to some non-limiting embodiments or aspects;

FIG. 27C is a side view of the pour-in opening of FIG. 27B, according to some non-limiting embodiments or aspects;

FIG. 27D is an illustration of the pour-in opening shown in FIG. 27B affixed to a mixing vessel, according to some non-limiting embodiments or aspects;

FIG. 28 is a sample method of using a pour-in opening, according to some non-limiting embodiments or aspects;

FIG. 29A is a dispenser assembly for dispensing a drink product from a drink maker, according to some non-limiting embodiments or aspects;

FIG. 29B is a dispenser assembly for dispensing a drink product from a drink maker, according to some non-limiting embodiments or aspects;

FIG. 29C is a dispenser assembly for dispensing a drink product from a drink maker, according to some non-limiting embodiments or aspects;

FIG. 29D is a dispenser assembly for dispensing a drink product from a drink maker, according to some non-limiting embodiments or aspects;

FIG. 30A is a dispenser assembly for dispensing a drink product from a drink maker, according to some non-limiting embodiments or aspects;

FIG. 30B is a dispenser assembly for dispensing a drink product from a drink maker, according to some non-limiting embodiments or aspects;

FIG. 31A is a shroud for covering the dispenser assembly of FIGS. 29A-29D and FIGS. 30A-30B, according to some non-limiting embodiments or aspects;

FIG. 31B is a shroud for covering the dispenser assembly of FIGS. 29A-29D and FIGS. 30A-30B, according to some non-limiting embodiments or aspects;

FIG. 32 is a lower portion of a dispenser assembly for dispensing a drink product from a drink maker, according to some non-limiting embodiments or aspects; and

FIG. 33 is a lower portion of a dispenser assembly for dispensing a drink product from a drink maker adjacent a spout, according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, a controller, and/or the like).

To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the present disclosure, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and may include additional parts not listed, while terms such as “and/or” include one or more of the listed parts and combinations of the listed parts.

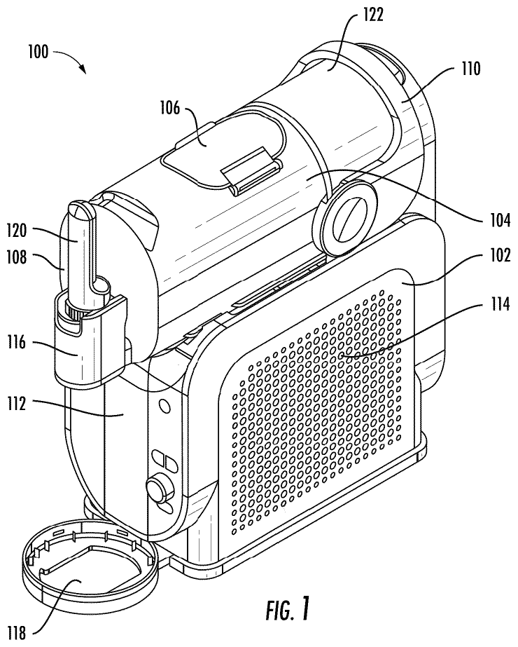

Referring now to FIG. 1, shown is a perspective view of a drink maker 100 (e.g., a frozen drink maker), according to some non-limiting embodiments or aspects. Drink maker 100 may include a housing 102 (e.g., a body of drink maker 100 enclosing at least some of the elements of drink maker 100) and a mixing vessel 104 (e.g., an at least partly enclosed volume for processing a drink product). Housing 102 may include a user interface 112 for receiving user inputs to control drink maker 100 (e.g., via one or more input components), and/or for outputting information (e.g., via one or more output devices). User interface 112 may include one or more buttons, dials, switches, touchscreens, indicators, light-emitting diodes (LEDs), and the like. User interface 112 may display status information including, for example, a temperature of a drink product within mixing vessel 104, an indicator of a drink type (e.g., a recipe) and/or a program currently being implemented, a timer associated with the progress of the program currently being implemented, and/or the like. User interface 112 may provide indicators and/or warnings to a user regarding, for example, when a program is complete, when a user is expected to perform an action associated with processing a drink product, and/or the like. User interface 112 may include a selectable menu of drink types (e.g., recipes) and/or programs for different types of drink products such as, without limitation, granita, milkshake, frappé, frozen latte, slush drink, smoothie, margarita, daiquiri, piña colada, slushie, cool drink, semi-frozen drink, frozen drink, alcohol-based drink, non-alcohol-based drink, and the like, or any suitable combination of the foregoing.

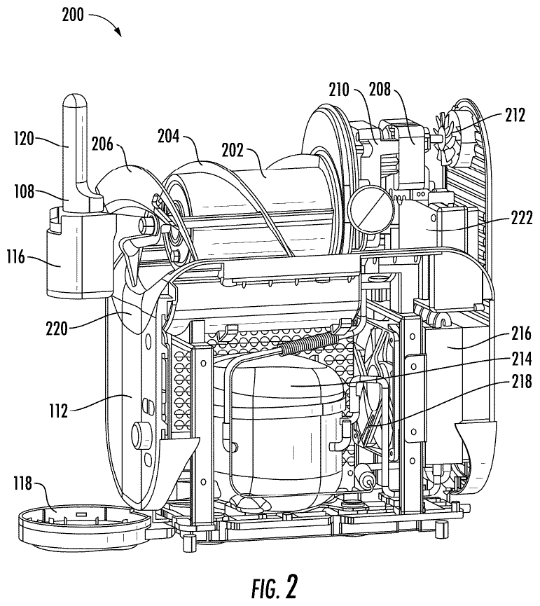

Housing 102 may include at least one ventilation panel 114 (e.g., an at least partly air-permeable wall) along a side of housing 102. Ventilation panel 114 may be removable from housing 102. Ventilation panel 114 may include a plurality of openings (e.g., holes) that facilitate air flow to aid in cooling components within housing 102. For example, a cooling fan (e.g., a compressor fan 218, as shown in FIG. 2) may draw cooler air into housing 102 through the rear of drink maker 100 (e.g., a rear panel with vents) and expel warmer air from housing 102 through at least one ventilation panel 114. In some non-limiting embodiments or aspects, a ventilation panel 114 may be arranged on each opposing side of housing 102. For example, a first ventilation panel 114 is shown on a first side of drink maker 100 in FIG. 1, and a second ventilation panel 114 is shown on an opposing side of drink maker 100 in FIG. 2 (visible through the exposed interior).

Housing 102 may include an upper housing section 122 that is configured to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include a pour-in opening 106, whereby mixing vessel 104 may receive a drink product for processing within mixing vessel 104. FIG. 1 shows pour-in opening 106 in a closed configuration with a hinged cover covering pour-in opening 106. The cover may be detachably removable and/or moveable to open or close pour-in opening 106. Pour-in opening 106 may be dimensioned (e.g., configured with a narrow gap into the internal chamber of mixing vessel 104) and/or include a grate (e.g., intermittent blocking elements arranged over the gap into the internal chamber of mixing vessel 104) to inhibit a user from reaching a digit into mixing vessel 104 when pour-in opening 106 is open (e.g., when the cover is not installed). Mixing vessel 104 may include a dispenser assembly 108 having a user handle 120 (e.g., for operating dispenser assembly 108), a spout (not shown), and a spout shroud 116 (e.g., a cover at least partly enclosing over the spout). Dispenser assembly 108 may enable a user, by pulling down and/or outward on handle 120, to open a spout connected to a wall of mixing vessel 104, to dispense a processed (e.g., cooled) drink product from mixing vessel 104. The user may close the spout by pushing and/or releasing handle 120 back to an upright position (as shown in FIG. 1) and, thereby, stop the dispensing of the processed drink product.

Drink maker 100 may include a lever 110 that enables a locked coupling of mixing vessel 104 to housing 102 (e.g., to upper housing section 122). As shown in FIG. 1, lever 110 is in a locked and/or closed position, whereby mixing vessel 104 is engaged and/or coupled to housing 102 (e.g., upper housing section 122). In the closed and/or locked position, lever 110 may help to ensure (e.g., along with other components and features) that there is a water-tight seal between mixing vessel 104 and housing 102, to prevent leakage of drink product from mixing vessel 104. Lever 110 may be placed in the closed, coupled, and/or engaged position by sliding mixing vessel 104 up to and against upper housing section 122 and then rotating lever 110 in a clockwise (e.g., rearward) direction until its handle rests on or about the top surface of upper housing section 122. Mixing vessel 104 may be disengaged and/or decoupled from housing 102 (e.g., upper housing section 122) by pulling and/or rotating lever 110 in a counter-clockwise (e.g., frontward) direction toward the front of mixing vessel 104, which may cause lever 110 to release mixing vessel 104 from housing 102. Once released, mixing vessel 104 may slide in a forward direction (e.g., away from upper housing section 122) to be fully detached and/or removed from housing 102. Drink maker 100 may also include drip tray 118 positioned below dispenser assembly 108 and configured to collect any processed drink product that is not properly dispensed from mixing vessel 104 to a receiving vessel, for example, a drinking cup. Drip tray 118 may be removably attachable to a base of housing 102.

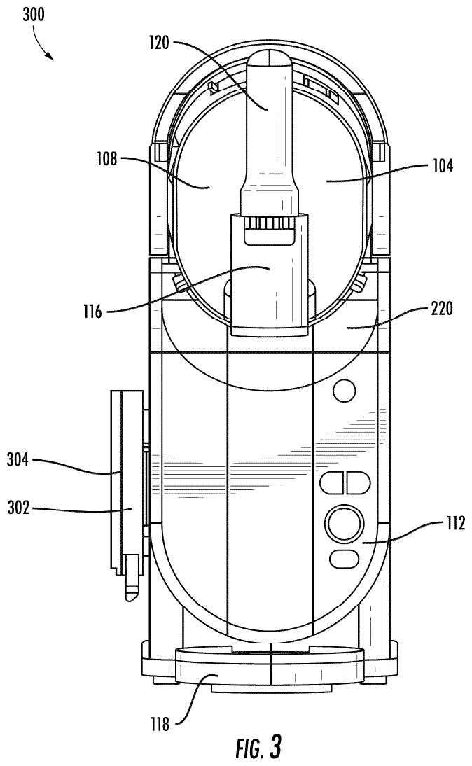

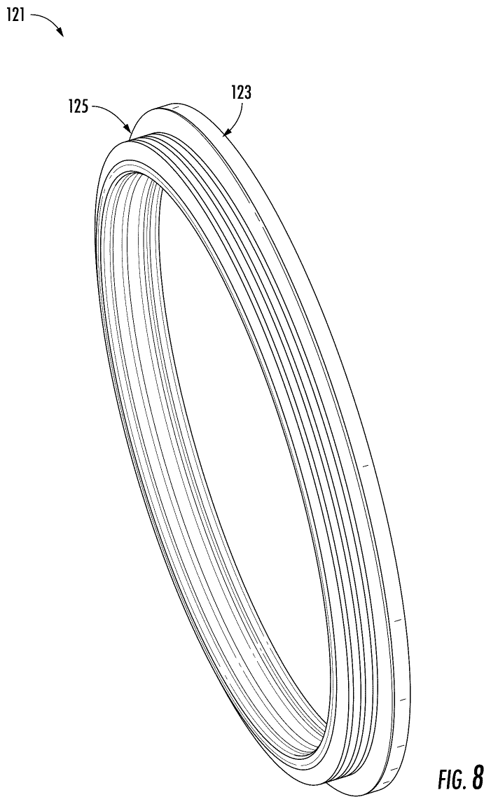

A flexible seal (illustrated in FIG. 8) may be positioned between mixing vessel 104 and upper housing section 122. The flexible seal may include a face seal portion and/or a radial seal portion. If present, the face seal portion may provide an improved seal based on compression provided by lever 110 pushing mixing vessel 104 laterally against a wall of upper housing section 122. Mixing vessel 104 may have a substantially cylindrical shape with a base having an opening formed therein, and the opening may be sealed by the flexible seal when lever 110 is in the coupled position. An interlock switch may be implemented at upper housing section 122 that is activated when mixing vessel 104 is coupled to upper housing section 122 that prevents activation of drive motor 208 unless mixing vessel 104 is coupled to upper housing section 122. This may ensure that a user is not exposed to a moving dasher 204, for example. Drink maker 100 may also include a drip tray 118 being positioned below dispenser assembly 108 and arranged to collect any drink product that is not properly dispensed from mixing vessel 104 to, for example, a user cup. Drip tray 118 may be attachably removable from its operational position shown in FIG. 1. For example, drip tray 118 may be mounted and/or stored on a side panel of housing 102, as illustrated in FIG. 3 as drip tray 304.

Referring now to FIG. 2, shown is a view 200 of various internal components within housing 102 and mixing vessel 104 of drink maker 100 of FIG. 1, according to some non-limiting embodiments or aspects. Drink maker 100 may include a cylindrical evaporator 202 (e.g., a heat exchanger that absorbs thermal energy from the drink product) that is surrounded by a dasher 204 (e.g., an auger). Evaporator 202 may include and/or be enclosed by a cylindrical drum (e.g., a smooth metal housing configured to act as a surface for drink product to contact and exchange heat energy with evaporator 202). Dasher 204 may include one or more mixing blades and/or protrusions that extend helically around evaporator 202. Dasher 204 may be driven to rotate by a central drive shaft within mixing vessel 104. The drive shaft may be surrounded by evaporator 202, and evaporator 202 may be configured in a fixed position while drive shaft rotates within evaporator 202. The drive shaft may be coupled via a gear assembly 210 to a drive motor 208. In some non-limiting embodiments or aspects, drive motor 208 may be an alternating current (AC) motor, but another type of motor may be used such as, without limitation, a direct current (DC) motor. Drive motor 208 may include a motor fan 212 configured to provide air cooling for drive motor 208. While FIG. 2 shows drive motor 208 being not coaxially aligned with the drive shaft used to rotate dasher 204, in some non-limiting embodiments or aspects, drive motor 208 may be aligned coaxially with the drive shaft. During processing of a drink product, drive motor 208 may be continuously operated at one or more speeds to drive continuous rotation of dasher 204 and, thereby, provide continuous mixing of the drink product within mixing vessel 104.

As referenced above, drink maker 100 may include a removably attachable drip tray 118, which may be moved from the operational position shown in FIGS. 1 and 2. For example, drip tray 118 may be mounted and/or stored on a side panel of housing 102 (e.g., on ventilation panel 114 shown in FIG. 1; see also drip tray 118 illustrated in FIG. 3 as drip tray 118'). In some non-limiting embodiments or aspects, the rotation of dasher 204 may cause the helically arranged blades to push the cooling drink product to the front of mixing vessel 104. During processing, portions of the drink product may freeze against the surface of evaporator 202 as a result of being cooled by evaporator 202. In some non-limiting embodiments or aspects, the blades of the rotating dasher 204 may scrape frozen portions of the drink product from the surface of evaporator 202 while concurrently mixing and pushing the cooling drink product towards the front of mixing vessel 104.

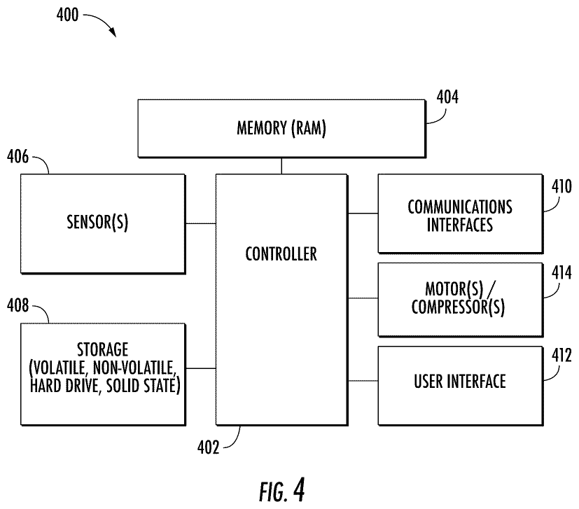

Drink maker 100 may include a cooling circuit (e.g., a refrigeration system) to provide cooling of a drink product and/or to control the temperature of a drink product within mixing vessel 104. The cooling circuit may include a compressor 214, evaporator 202, a condenser 216, a condenser fan 218, a bypass valve, and conduit that carries refrigerant in a closed loop among the cooling circuit components to facilitate cooling and/or temperature control of a drink product in mixing vessel 104. Operations of the cooling circuit may be controlled by a controller (see, e.g., controller 402, as described further with respect to FIG. 4), which may be positioned proximally to user interface 112, drive motor 208, and/or elsewhere in housing 102. In some non-limiting embodiments or aspects, drink maker 100 may include a printed circuit board assembly (PCBA) 222 of one or more printed circuit boards (PCBs) within housing 102. As will be explained with respect to FIG. 4, PCBA 222 may include a control system 400 configured to automatically control certain operations of drink maker 100, and control system 400 may include controller 402.

Drink maker 100 may also include a condensation collection tray 220 configured to collect any liquid condensation caused by cooling from evaporator 202, as well as to catch accidentally spilled drink product caused by user error interacting with pour-in opening 106. FIG. 2 shows condensation collection tray 220 in the inserted position. Condensation collection tray 220 may be insertably removable from a slot within and/or on housing 102. Condensation collection tray 220 may be inserted to enable the collection of liquid (e.g., condensation), removed for a user to empty the contents of condensation collection tray 220, and then re-inserted into the slot for subsequent liquid collection. Condensation collection tray 220 is configured to prevent liquid runoff into, onto, or down the outer surface of housing 102.

Referring now to FIG. 3, shown is a front view 300 of drink maker 100 of FIGS. 1 and 2, according to some non-limiting embodiments or aspects. Drink maker 100 may include a user interface 112 on a front surface of housing 102. In some non-limiting embodiments or aspects, user interface 112 may be located on a side, top, or back of housing 102. Drink maker 100 may include a power interface (not shown) configured to receive AC power from a power outlet. In some non-limiting embodiments or aspects, drink maker 100 may include one or more batteries housed within housing 102 and configured to provide power to various components of drink maker 100. Drink maker 100 may include a mount 302 on a side of housing 102 where drip tray 118 may be mounted when not in use (shown as drip tray 118′ in FIG. 3), such as during storage and/or transport of drink maker 100.

Referring now to FIG. 4, shown is a block diagram of an exemplary control system 400 of drink maker 100, according to some non-limiting embodiments or aspects. Control system 400 may include a microcontroller, a processor, a system-on-a-chip (SoC), a client device, and/or a physical computing device, and may include hardware and/or virtual processor(s). In some non-limiting embodiments or aspects, control system 400 and its elements, as shown in FIG. 4, each may relate to physical hardware, emulators, and/or virtual machines.

Control system 400 may include a user interface 412 (e.g., user interface 112), having, for example, a keyboard, keypad, one or more buttons, dials, touchpad, or sensor readout (e.g., biometric scanner), and one or more output devices, such as displays, speakers for audio, and/or light indicators (e.g., LED indicators). Control system 400 may also include one or more communications interfaces 410, such as a network communication unit that may include a wired communication component and/or a wireless communication component, which may be communicatively coupled to controller 402 (e.g., one or more hardware processors). The network communication unit may utilize any of a variety of proprietary or standardized network protocols (e.g., Ethernet, transfer control protocol/internet protocol (TCP/IP), etc.) to effect communications between controller 402 and another device, network, or system. Network communication units may also include one or more transceivers that utilize the Ethernet, power line communication (PLC), Wi-Fi®, cellular, and/or other communication methods. For example, control system 400 may send one or more communications associated with a status of drink maker 100 to a mobile device of a user, e.g., send an alert to the mobile device when a program is complete and/or a drink product is ready for dispensing, to indicate that mixing vessel 104 is low or out of a drink product, or to indicate another status or condition of drink maker 100.

Control system 400 may include a processing element, such as controller 402, that contains one or more hardware processors, where each hardware processor may have a single or multiple processor cores. In some non-limiting embodiments or aspects, controller 402 may include at least one shared cache that stores data (e.g., computing instructions) that are utilized by one or more other components of controller 402. For example, the shared cache may be a locally cached data stored in a memory for faster access by components of the processing elements that make up controller 402. Examples of processors may include, but are not limited to, a central processing unit (CPU), a microprocessor, and/or the like. Controller 402 may utilize a computer architecture base on, without limitation, the Intel® 8051 architecture, Motorola® 68HCX, Intel® 80X86, and/or the like. Controller 402 may include, without limitation, an 8-bit, 12-bit, 16-bit, 32-bit, or 64-bit architecture. Although not illustrated in FIG. 4, the processing elements that make up controller 402 may also include one or more other types of hardware processing components, such as graphics processing units (GPUs), application specific integrated circuits (ASICs), field-programmable gate arrays (FPGAs), digital signal processors (DSPs), and/or the like.

As shown in FIG. 4, memory 404 may be operatively and communicatively connected to controller 402. Memory 404 may be a non-transitory medium configured to store various types of data. For example, memory 404 may include and/or be associated with one or more storage devices 408 that include a non-volatile storage device and/or volatile memory. Volatile memory, such as random-access memory (RAM), may be any suitable non-permanent storage device. The non-volatile storage devices 408 may include one or more disk drives, optical drives, solid-state drives (SSDs), tape drives, flash memory, read-only memory (ROM), and/or any other type of memory designed to maintain data for a duration of time after a power loss or shut down operation. In certain configurations, the non-volatile storage devices 408 may be used to store overflow data if allocated RAM is not large enough to hold all working data. The non-volatile storage devices 408 may also be used to store programs that are loaded into the RAM when such programs are selected for execution. Data store and/or storage devices 408 may be configured to store a plurality of drink product making and/or processing instruction programs associated with a plurality of drink product processing sequences. Such drink product making and/or processing instruction programs may include instructions for controller 402 to: start or stop one or more motors and/or compressors 414 (e.g., such as drive motor 208 and/or compressor 214), start or stop compressor 214 to regulate a temperature of a drink product being processed within mixing vessel 104, operate the one or more motors and/or compressors 414 (e.g., drive motor 208 and/or compressor 214) at certain periods during a particular drink product processing sequence, operate drive motor 208 at certain speeds during certain periods of time of a program, issue one or more cue instructions to user interface 412 (e.g., user interface 112) that are output to a user to illicit a response, action, and/or input from the user, and/or the like.

In some non-limiting embodiments or aspects, one or more drink data objects (e.g., groupings of structured data associated with a drink type that may include program instructions related to the drink type) may be stored in memory 404 in the form of a digital object (or record) representing a type of drink (e.g., slush, cocktail, frappé, juice, milkshake, etc.). Each drink data object may define and/or reference data such as temperature values and/or other setting values associated with the drink type, where the drink data object also may include computing instructions and/or computer programs defining functions, actions, and/or processing sequences to be performed on the digital object.

Software programs may be developed, encoded, and compiled in a variety of computing languages for a variety of software platforms and/or operating systems and subsequently loaded and executed by controller 402. In some non-limiting embodiments or aspects, the compiling process of the software program may transform program code written in a programming language to another computer language such that the controller 402 is able to execute the programming code. For example, the compiling process of the software program may generate an executable program that provides encoded instructions (e.g., machine code instructions) for controller 402 to accomplish specific, non-generic, particular computing functions.

After the compiling process, the encoded instructions may be loaded as computer executable instructions or process steps to controller 402 from storage 408, from memory 404, and/or embedded within controller 402 (e.g., via a cache or on-board ROM). Controller 402 may be configured to execute the stored instructions or process steps in order to perform instructions or process steps to transform the electronic control system 400 into a non-generic, particular, specially programmed machine or apparatus. Stored data, e.g., data stored by a data store and/or storage device 408, may be accessed by controller 402 during the execution of computer executable instructions or process steps to instruct one or more components within control system 400 and/or other components or devices external to control system 400. For example, the drink data objects associated with drink types may be arranged in a lookup table and/or database within storage device 408 and be accessed by controller 402 when processing a particular drink type selected by a user via user interface 412 (e.g., user interface 112).

User interface 412 (e.g., user interface 112) may include a display, positional input component (e.g., a mouse, touchpad, touchscreen, or the like), keyboard, keypad, one or more buttons, one or more dials, a microphone, speaker, or other forms of user input and output devices. The components of user interface 412 may be communicatively coupled to controller 402. When an output device of user interface 412 is (or includes) a display, the display may be implemented in various ways, including by a liquid crystal display (LCD), a cathode-ray tube (CRT) display, a light emitting diode (LED) display, such as an organic LED (OLED) display, and/or the like.

Sensor(s) 406 may include one or more sensors that detect and/or monitor conditions of a drink product within mixing vessel 104, conditions associated with a component of drink maker 100, and/or conditions of a refrigerant or coolant within the cooling circuit. Conditions may include, without limitation, rotation, speed of rotation, and/or movement of a device or component (e.g., drive motor 208, the drive shaft driven thereby, dasher 204, etc.), rate of such movement, frequency of such movement, direction of such movements, motor current, motor voltage, motor power, motor torque, temperature, pressure, fluid level in mixing vessel 104, position of a device or component (e.g., whether pour-in opening 106 is open or closed), and/or the presence of a device or component (e.g., whether shroud 116 is installed or not). Types of sensors may include, for example, electrical metering chips, Hall sensors, pressure sensors, temperature sensors, optical sensors, current sensors, torque sensors, voltage sensors, cameras, other types of sensors, or any suitable combination of the foregoing. Drink maker 100 may include one or more temperature sensors 406 positioned in various locations within mixing vessel 104 such as, for example, on or about the lower front area within mixing vessel 104, on or about the upper front area within mixing vessel 104, on or about the upper rear area within mixing vessel 104, within one or more coils of evaporator 202, and/or within housing 102.

Sensor(s) 406 may also include one or more safety and/or interlock switches that prevent or enable operation of certain components (e.g., drive motor 208, compressor 214, etc.), when certain conditions are met (e.g., when a lid or cover for opening 106 is attached or closed, when a sufficient level of drink product is in mixing vessel 104, when lever 110 is moved to a coupled position, when mixing vessel 104 is secured to housing 102, and/or the like). It will be appreciated that control system 400 may include other electronic components, such as power sources and/or analog-to-digital converters, not explicitly shown in FIG. 4.

In some non-limiting embodiments or aspects, control system 400 and/or controller 402 may include an SoC having multiple hardware components, including but not limited to: a microcontroller, a microprocessor or digital signal processor (DSP) core, and/or multiprocessor SoCs (MPSoC) having more than one processor cores; memory blocks including a selection of read-only memory (ROM), random access memory (RAM), erasable programmable read-only memory (EPROM), electronically erasable programmable read-only memory (EEPROM), compact disc read-only memory (CD-ROM), digital versatile disc read-only memory (DVD-ROM), and/or flash memory; timing sources, including oscillators and phase-docked loops; peripherals, including counter-timers, real-time timers, and power-on reset generators; external interfaces, including universal serial bus (USB), FireWire®, Ethernet, universal synchronous/asynchronous receiver/transmitter (USART), serial peripheral interface (SPI); analog interfaces including analog-to-digital converters (ADCs) and digital-to-analog converters (DACs); voltage regulators and power management circuits; or any combination thereof.

A SoC may include both the hardware, described above, and software controlling the microcontroller, microprocessor, and/or DSP cores, peripherals, and interfaces. SoCs may be developed from pre-qualified hardware blocks for the hardware elements (e.g., referred to as modules or components which represent an IP core or IP block), together with software drivers that control their operation. The above listing of hardware elements is not exhaustive. A SoC may include protocol stacks that drive interfaces like a universal serial bus (USB).

Once the overall architecture of the SoC has been defined, individual hardware elements may be described in the abstract language register-transfer level (RTL). RTL may be used to define the circuit behavior. Hardware elements may be connected together in the same RTL language to create the full SoC configuration. RTL is a design abstraction that models a synchronous digital circuit in terms of the flow of digital signals (e.g., data) between hardware registers, and the logical operations performed on those signals. RTL abstraction may be used in hardware description languages (HDLs), such as Verilog® and very high-speed integrated circuit (VHSIC) hardware description language (VHDL), to create high-level representations of a circuit, from which lower-level representations and ultimately actual wiring may be derived. Verilog® is standardized as Institute of Electrical and Electronic Engineers (IEEE) 1364 and is a hardware description language (HDL) used to model electronic systems. In some non-limiting embodiments or aspects, various components of control system 400 may be implemented on a PCBA, such as PCBA 222.

With further reference to FIGS. 1-4, and in some non-limiting embodiments or aspects, a user may fill mixing vessel 104 via pour-in opening 106 with ingredients associated with a drink product, where one or more ingredients may be added at a time or added in pre-mixed form. The user may select the type of drink product to be processed via user interface 112. For example, the user may select a drink type for “margarita”, or a more generic drink type such as “alcohol drink” or “cocktail.” In some non-limiting embodiments or aspects, the user may select the drink product type and/or program before filling mixing vessel 104, and user interface 112 may provide one or more indicators or cues (e.g., visual feedback, aural feedback, etc.) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to controller 402 that indicates when mixing vessel 104 is sufficiently filled or not filled. Controller 402 may prevent operations of drink maker 100 (e.g., prevent activation of drive motor 208 and/or other components) if the fill sensors indicate that mixing vessel 104 is not sufficiently filled. A lid sensor may be associated with opening 106, whereby the lid sensor may send an open and/or closed signal to controller 402 that indicates whether opening 106 is open or closed. Controller 402 may prevent operations of drink maker 100 if the lid sensor indicates that opening 106 is open and/or not closed. Depending on the sensed condition, user interface 112 may provide an indication regarding the condition (e.g., that mixing vessel 104 is sufficiently filled or not sufficiently filled, that opening 106 is not closed, and/or the like) to enable a user to take appropriate action(s).

Once mixing vessel 104 is filled with ingredients, the user may provide an input (e.g., a button press) to start processing of the drink product based on the selected drink type. Processing may include activation of drive motor 208 to drive rotation of dasher 204 and/or blade 206 to effect mixing of the ingredients of the drink product. Processing may also include activation of the cooling circuit, including activation of compressor 214 and condenser fan 218. The compressor 214 may facilitate refrigerant flow through one or more coils of evaporator 202 and through condenser 216 to provide cooling and/or temperature control of the drink product within mixing vessel 104. Controller 402 may control operations of various components, such as drive motor 208 and compressor 214. To regulate temperature at a particular setting associated with a drink type or program, controller 402 may activate/start and/or deactivate/stop compressor 214 to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. The amount of particles and/or texture of a drink product may correspond to a temperature of the drink product. For example, as the temperature of the drink product becomes cooler, more particles may form, larger particles may form, etc., and the drink product may become slushier. User interface 112 may enable a user to fine tune and/or adjust a preset temperature associated with a drink type to enable a user to adjust the temperature and/or texture (e.g., thickness) of a drink product to a more desirable temperature and/or texture.

Controller 402 may perform processing of the drink product for a set period of time in one or more phases and/or until a target temperature and/or texture is determined. Controller 402 may receive one or more temperature signals from one or more temperature sensors 406 within mixing vessel 104 to determine the temperature of the drink product. In some non-limiting embodiments or aspects, controller 402 may determine the temperature of the drink product by determining an average temperature among temperatures detected by multiple temperature sensors 406. In some non-limiting embodiments or aspects, controller 402 may determine the temperature of the drink product based on the detected temperature from one sensor 406 within mixing vessel 104, and/or based on a temperature of the refrigerant detected by a refrigerant temperature sensor 406. Once a phase and/or sequence of a program is determined to be complete by controller 402, controller 402 may, via user interface 112, provide a visual and/or audio indication that the program is complete and the processed drink product is ready for dispensing. In response, a user may place a cup or other receiving vessel below dispenser assembly 108 and pull handle 120 in an outward/downward direction to open a spout located at about the lower front wall of mixing vessel 104, resulting in dispensing of the drink product into the cup or other receiving vessel. Once filled, the user may close the spout by releasing/pushing handle 120 back to its upright position, as shown in FIG. 2. In implementations where handle 120 is spring-biased to the closed position, the user may release their hold of handle 120 and, thereby allow a spring force to move handle 120 back and rotationally upward, away from the user to the upright and closed position.

With further reference to FIGS. 1-4, drink maker 100 may determine when a phase change of a drink product occurs during processing by drink maker 100 and take action accordingly. In some non-limiting embodiments or aspects, a phase change temperature value indicative of a point at which the phase change occurs may be determined, and a target temperature value to attain and maintain for the drink product during processing may be determined from the phase change temperature value. Other determinations may be made and actions taken based on the determination of the phase change and phase change temperature value. In some non-limiting embodiments or aspects, a predetermined target temperature associated with a drink type (e.g., selected by a user or determined by processing a drink product) may be accessed, for example, from a memory 404 of the drink maker 100, over a wireless interface, and/or the like.

As described herein, during the cooling of the drink product, a phase change of the drink product may be expected to occur before the target temperature is reached. When controller 402 of drink maker 100 determines that the target temperature associated with a drink type (e.g., juice, cocktail, milkshake, soft drink, etc.) is attained, controller 402 may determine whether a phase change has already been detected during processing. Additionally, or alternatively, when controller 402 determines that a phase change has occurred, controller 402 may determine whether the target temperature associated with the drink type has already been attained during processing. In either case, if the phase change has not occurred before the predetermined target temperature is reached, this may be indicative of a supercooling event having occurred, or user error having occurred. In the latter scenario, the drink product being processed may have a phase change temperature value lower than the phase change temperature value associated with the drink type selected by the user (and thus a lower target temperature than the predetermined target temperature for the drink type).

In some non-limiting embodiments or aspects, in response to a phase change having not occurred before the predetermined target temperature is reached, controller 402 may be configured to leave the cooling circuit on, and in some cases pulse (e.g., periodically activate and deactivate) drive motor 208 to trigger nucleation until a phase change is determined to occur. If a phase change is detected before the predetermined target temperature is reached, the cooling circuit may be cycled (e.g., turned off and on one or more times) to maintain the temperature at or about the target temperature (or an adjusted target temperature if a user has specified any temperature and/or thickness adjustments).

In some non-limiting embodiments or aspects, if a phase change is not detected before the predetermined target temperature is reached, but rather after the continued cooling and/or pulsing of drive motor 208, the cooling circuit may be cycled in a controlled fashion and dasher 204 left on until the predetermined target temperature is reached (plus or minus any user adjustments), as described herein. If supercooling was the reason that the phase change was not detected before the predetermined target temperature value was reached, the controlled pulsing of drive motor 208 may result in the phase change being triggered and the drink product having an expected desired thickness. If, however, the phase change was not detected before the predetermined target temperature value because of the aforementioned user error, then the target temperature may be recalculated, for example, based on the determined phase change temperature value, and the cooling circuit continually cycled until the recalculated target temperature is achieved.

In some non-limiting embodiments or aspects, a minimum drink product temperature may be predefined (e.g., a minimum temperature threshold for which drink maker 100 is not capable of producing a lower temperature or for which doing so could damage drink maker 100). Controller 402 may be configured to detect when the temperature has reached the minimum threshold and control one or more actions to be taken. For example, the user may be alerted (e.g., visually, haptically, and/or aurally) through one or more output devices of drink maker 100 (e.g., displays, speakers, vibration motors, light indicators, etc.) that drink maker 100 cannot make an adequate slush for the drink product. Controller 402 may also be configured, when the minimum temperature is detected, to maintain the drink product at the minimum temperature as a cold drink and to alert the user of same.

In some non-limiting embodiments or aspects, a minimum phase change temperature value may be predefined. As described herein, the target temperature value of a drink product being chilled may be lower than the phase change temperature value. Controller 402 may be configured to determine when a determined phase change temperature value is below the minimum phase change temperature value, such that the target temperature will not be capable of being achieved by drink maker 100 because such target temperature would be below the minimum temperature threshold. Controller 402 may be configured to control one or more actions to be taken when it is determined that the determined phase change temperature value is below the minimum phase change temperature value. For example, controller 402 may cause one or more output devices of drink maker 100 to alert the user visually, haptically, and/or aurally, such as to indicate that drink maker 100 cannot make an adequate slush for the drink product. Controller 402 may also be configured, when it is determined that the determined phase change temperature value is below the minimum phase change temperature value, to maintain the drink product at the minimum temperature as a cold drink and to alert the user of same.

If a drink product does not have a high enough concentration of certain ingredients (e.g., sugar, alcohol, etc.), it may be difficult to reliably produce a slush from it, or doing so may damage drink maker 100, for reasons described herein. A maximum phase change temperature value threshold value may be defined, and controller 402 may be configured to determine if a determined phase change temperature value exceeds the maximum phase change temperature value. Controller 402 may control performance of one or more actions if the threshold value is exceeded, for example, alerting a user and/or performing corrective actions.

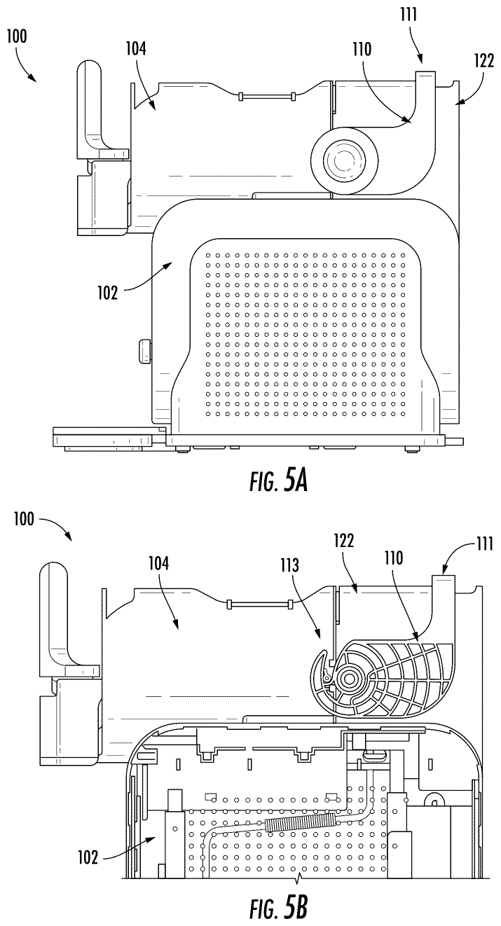

As previously mentioned, the drink maker 100 may include upper housing section 122 arranged to couple with a rear end of mixing vessel 104 when mixing vessel 104 is attached to housing 102. Drink maker 100 may also include lever 110 that enables mixing vessel 104 to be coupled (e.g., locked, attached to, and/or affixed to) to housing 102 (e.g., upper housing section 122). Lever 110 may also enable mixing vessel 104 to be unlocked and decoupled from housing 102 (e.g., upper housing section 122). Features of lever 110 are shown in FIGS. 5A and 5B.

Referring now to FIGS. 5A and 5B, FIG. 5A shows a side view of drink maker 100, with mixing vessel 104 in a coupled position relative to upper housing section 122, according to some non-limiting embodiments or aspects. FIG. 5B shows a side view of drink maker 100 illustrated in FIG. 5A, with some features of housing 102 and lever 110 shown in partial cross-section. Lever 110 may include a handle 111 that may be gripped by a user and moved relative to upper housing section 122. Handle 111 may be moved into the position shown in FIGS. 5A and 5B to couple mixing vessel 104 into place on drink maker 100 and may be moved away from upper housing section 122 and/or toward a front of housing 102 to decouple mixing vessel 104 from drink maker 100. When handle 111 is moved relative to upper housing section 122, handle 111 may activate a cam 113, which engages mating features on mixing vessel 104 to either couple or uncouple mixing vessel 104 relative to upper housing section 122. In some non-limiting embodiments or aspects, handle 111 may move less than 90° relative to upper housing section 122 when moving between the coupled position and the uncoupled position.

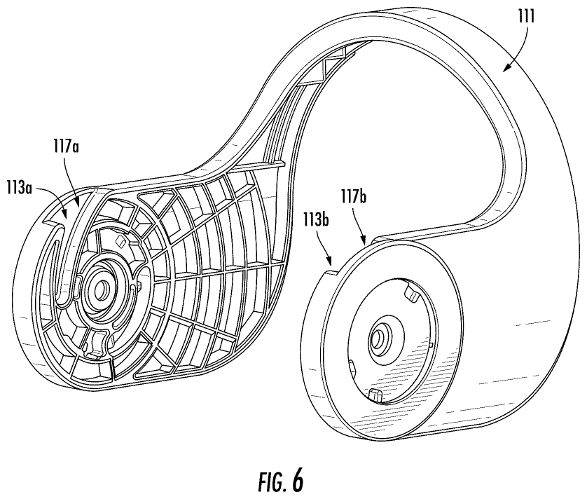

Referring now to FIG. 6, shown is a detailed view of a handle 111 with two cams 113a, 113b positioned on opposing sides, according to some non-limiting embodiments or aspects. Handle 111 may include one, two, three, four, or more cams 113, if desired. As handle 111 is moved, cams 113a, 113b may rotate with respect to upper housing section 122.

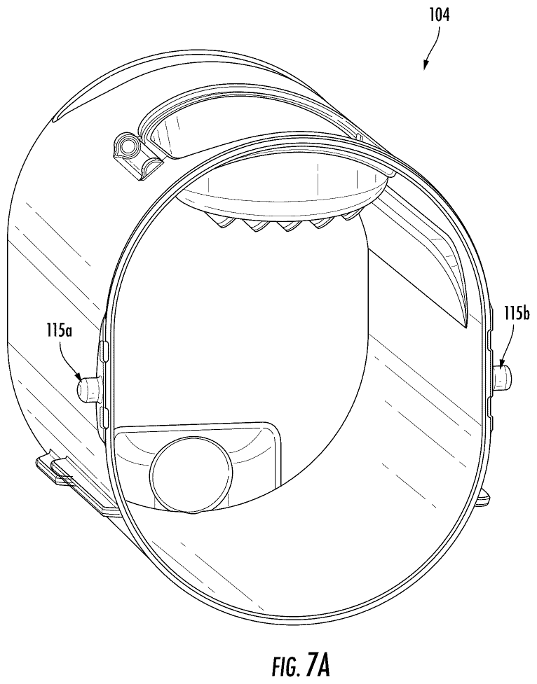

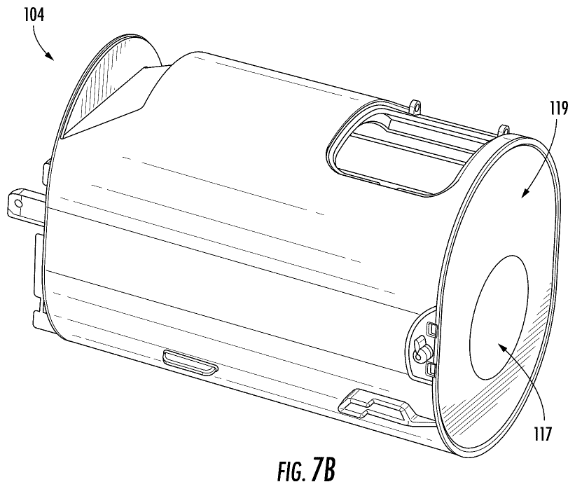

Referring now to FIG. 7A, shown is a rear view of mixing vessel 104, according to some non-limiting embodiments or aspects. Mixing vessel 104 may include protrusions 115a, 115b on opposing outer sides, near the rear bottom of mixing vessel 104. With further reference to FIGS. 6 and 7A, protrusions 115a, 115b may be shaped and positioned to engage with cams 113a, 113b on handle 111. In particular, cams 113a, 113b may have channels and/or cam paths 109a, 109b through which protrusions 115a, 115b may slide, respectively. As cams 113a, 113b rotate toward the back of housing 102, protrusions 115a, 115b may slide along cam paths 109a, 109b and may be pulled toward upper housing section 122 and the rear of housing 102, causing mixing vessel 104 to press against upper housing section 122 and form a water-tight seal with housing 102. When cams 113a, 113b are rotated toward the front of drink maker 100, protrusions 115a, 115b may be pushed away from upper housing section 122, causing mixing vessel 104 to be decoupled from contact with upper housing section 122.

In some non-limiting embodiments or aspects, cam 113 may be an over-center cam, as shown in FIG. 5B and FIG. 6, or cam 113 may have alternative geometry. In the disclosed drink maker 100, cam 113 may retain mixing vessel 104 on housing 102 when lever 110 is in the coupled position. As previously discussed, mixing vessel 104 may have an overall cylindrical or approximately cylindrical shape and may include an opening 117 (shown in FIG. 7B) at its rear end that couples to upper housing section 122.

Referring now to FIG. 7B, shown is a rear perspective view of mixing vessel 104, according to some non-limiting embodiments or aspects. Mixing vessel 104 may have an opening 117 in a rear panel 119 of mixing vessel 104. Opening 117 may be positioned to face horizontally when mixing vessel 104 is in the coupled position on upper housing section 122. With further reference to FIGS. 6-7B, to move lever 110 into a coupled position, handle 111 may be moved toward upper housing section 122. When mixing vessel 104 is in a coupled position on upper housing section 122, lever 110, in cooperation with a flexible seal 121, may seal opening 117.

Referring now to FIG. 8, shown is a flexible seal 121, according to some non-limiting embodiments or aspects. Flexible seal 121 may be formed of any elastomeric material, such as natural or synthetic rubber, silicone, neoprene, chloroprene, polyisoprene, polybutadiene, or combinations thereof. Flexible seal 121 may be independent of housing 102. If desired, flexible seal 121 may be affixed to upper housing section 122. Flexible seal 121 may be a single member including a face seal portion 123 and/or a radial seal portion 125, as shown in FIG. 8. Additionally, or alternatively, face seal portion 123 and radial seal portion 125 may be implemented with distinct flexible seals 121.

In some non-limiting embodiments or aspects, face seal portion 123 may have an annular shape with a primary dimension that is vertically aligned to form a vertically aligned seal between a horizontal face of upper housing section 122 and a horizontal edge of mixing vessel 104. When in the coupled position, face seal portion 123 may interface a vertically aligned surface of upper housing section 122 to a vertically aligned side of mixing vessel 104. Radial seal portion 125 may include multiple flexible annular ribs, as shown in FIG. 8. Radial seal portion 125 may form a radial seal relative to the horizontal axis of mixing vessel 104, sealing against an inside (e.g., cylindrical) surface of mixing vessel 104. Flexible seal 121 may include at least one of a radial seal portion 125 and a face seal portion 123.

Previously known drink makers do not include both a face seal and a radial seal for a mixing vessel. In some non-limiting embodiments or aspects, face seal portion 123 of flexible seal 121 may provide an improved seal based on compression provided by handle 111 pushing mixing vessel 104 laterally against a wall of upper housing section 122. Cam 113 also may allow high force on face seal portion 123 to be easily achieved and maintained. Since face seal portion 123 may serve as the primary seal, radial seal portion 125 size may be reduced, thereby lowering mixing vessel 104 resistance to seating and improving ease of use.

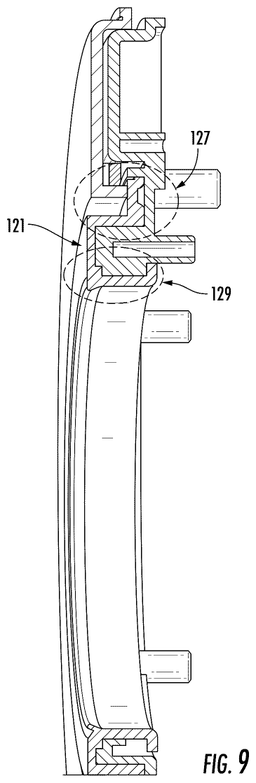

Referring now to FIG. 9, shown is a cross-sectional view of flexible seal 121 having a vessel seal portion 127 and an evaporator seal portion 129, according to some non-limiting embodiments or aspects. For example, flexible seal 121 may serve as the seal for mixing vessel 104 and/or evaporator 202. Vessel seal portion 127 of flexible seal 121 may create a watertight seal between mixing vessel 104 and upper housing section 122. Evaporator seal portion 129 of flexible seal 121 may seal evaporator 202 within mixing vessel 104. To move lever 110 from a coupled position to an uncoupled position, handle 111 may be moved away from upper housing section 122 and/or toward a front of housing 102, which may cause mixing vessel 104 to slide in a forward direction (e.g., away from upper housing section 122) to be fully detached and/or removed from housing 102. In some non-limiting embodiments or aspects, cam 113 may include an ejection feature to apply an ejection force to mixing vessel 104 to eject past radial seal portion 125.

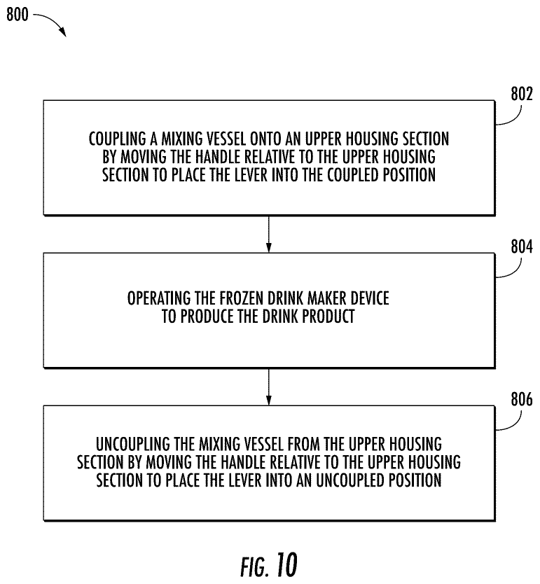

Referring now to FIG. 10, shown is a flow diagram of a method 800 of producing a frozen drink using a drink maker (e.g., drink maker 100). For example, drink maker 100 may include housing 102 having upper housing section 122 and lever 110 configured to move relative to upper housing section 122 between a coupled position and an uncoupled position, and mixing vessel 104 arranged to couple to upper housing section 122. Lever 110 may include handle 111 that is moveable to place lever 110 into the coupled position and/or the uncoupled position.

As shown in FIG. 10, method 800 may include, at step 802, coupling mixing vessel 104 onto upper housing section 122 by moving handle 111 relative to upper housing section 122 to place lever 110 into the coupled position. When in the coupled position, at least one of a face seal and a radial seal may be formed between mixing vessel 104 and upper housing section 122.

As shown in FIG. 10, method 800 may include, at step 804, operating drink maker 100 to produce the frozen drink. For example, evaporator 202 may cool a drink product in mixing vessel 104 and dasher 204 may mix drink product in mixing vessel 104.

As shown in FIG. 10, method 800 may include, at step 806, uncoupling mixing vessel 104 from upper housing section 122 by moving handle 111 relative to upper housing section 122 to place lever 110 into an uncoupled position.

In some non-limiting embodiments or aspects, coupling mixing vessel 104 onto upper housing section 122 may involve moving handle 111 toward upper housing section 122. In some non-limiting embodiments or aspects, uncoupling mixing vessel 104 from upper housing section 122 may involve moving handle 111 away from upper housing section 122 and/or toward a front of housing 102. Moving handle 111 relative to upper housing section 122 to place lever 110 into the coupled position may be accomplished by a user using only one hand. In some non-limiting embodiments or aspects, moving handle 111 relative to upper housing section 122 to place lever 110 into the uncoupled position may be accomplished by a user using only one hand. In some non-limiting embodiments or aspects, moving handle 111 relative to upper housing section 122 to position lever 110 from the coupled position to the uncoupled position may require moving handle 111 less than 90°relative to upper housing section 122.

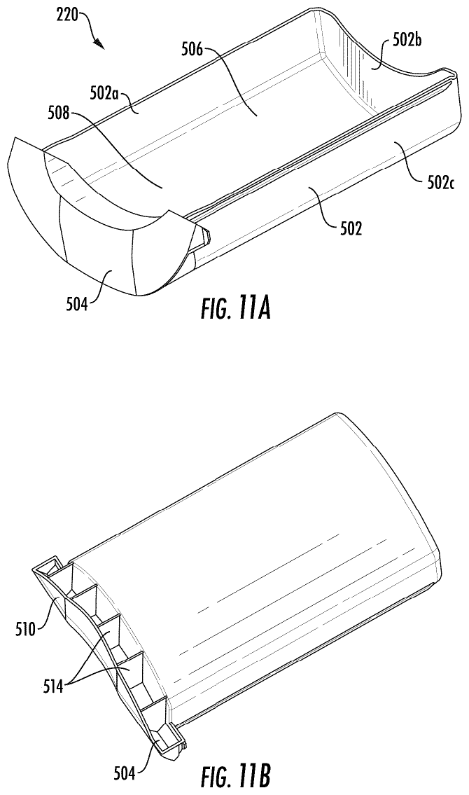

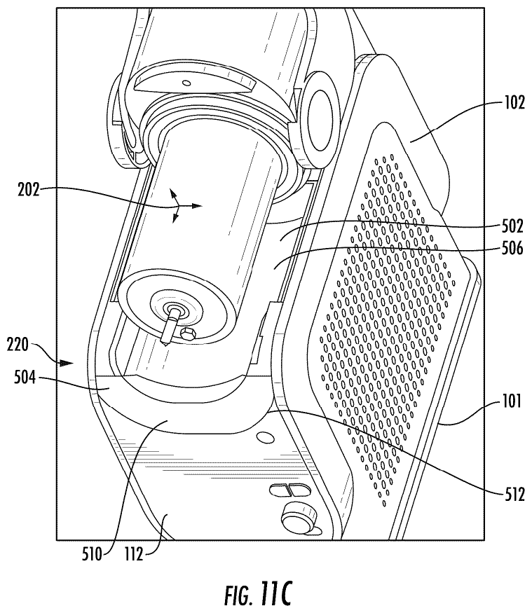

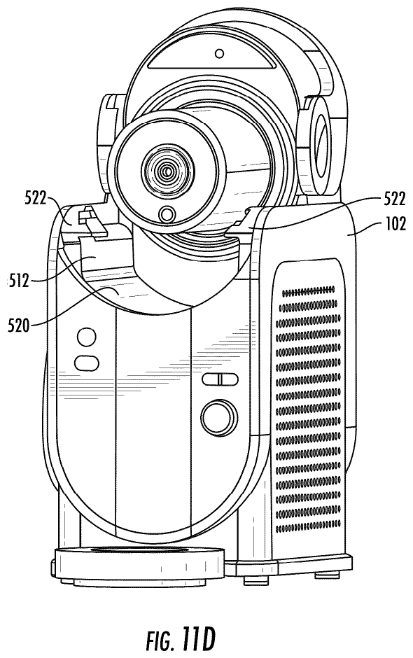

Referring now to FIGS. 11A and 11B, shown are perspective views of collection tray 220, according to some non-limiting embodiments or aspects. Collection tray 220 may include a collection portion 502 and a handle 504 that may be used to insert collection tray 220 into housing 102 and remove collection tray 220 from housing 102. Collection portion 502 may include three walls 502a, 502b, 502c extending generally upwards from an evaporator-facing surface 506. Together with handle 504, walls 502a, 502b, 502c and surface 506 may define a chamber 508 for collecting liquid, including condensation falling from mixing vessel 104 (e.g., caused by evaporator 202), spills, and water poured into mixing vessel 104 to clean the inside of mixing vessel 104. A shape of the collection portion 502, including evaporator-facing surface 506, may correspond to an outer shape of mixing vessel 104 and/or evaporator 202. For example, the shape of evaporator-facing surface 506 may be semi-cylindrical to correspond to the cylindrical shape of mixing vessel 104. It will be appreciated that other suitable shapes may be use for evaporator-facing surface 506, including rectangular. Chamber 508 may have a liquid volume capacity of about 16 ounces. In some non-limiting embodiments or aspects, chamber 508 may have a liquid volume capacity of more or fewer than 16 ounces. As shown in FIG. 11B, an underside of handle 504 may define one or more ribs 514 for adding structural integrity between a user-facing surface 510 of handle 504 and the main body of collection tray 220. Collection tray 220 may be made from dishwasher-safe materials (e.g., resistant to high water temperature and impervious to water penetration) for easy cleaning.

Referring now to FIG. 11C, shown is collection tray 220 inserted into housing 102 of drink maker 100, according to some non-limiting embodiments or aspects. For ease of illustration, housing 102 is shown with mixing vessel 104 and attached dispenser assembly 108 removed. When fully inserted, user-facing surface 510 of handle 504 may sit flush with user interface 112 of housing 102. In the inserted position, collection tray 220 may be spaced vertically above a bottom side 101 of housing 102. Once liquid is collected in chamber 508, the user may remove collection tray 220 for disposal of the collected liquid and cleaning of collection tray 220.

Referring now to FIG. 11D, shown is housing 102 with collection tray 220 removed, according to some non-limiting embodiments or aspects. As shown in FIG. 11D, housing 102 may include a top surface 520 for supporting collection tray 220 when collection tray 220 is inserted into housing 102. A shape of top surface 520 may be semi-cylindrical to correspond to the semi-cylindrical shape of evaporator-facing surface 506. Housing 102 may also include one or more rails 522 defining one or more slots 512 between rails 522 and top surface 520. Rails 522 may help guide the user in inserting collection tray 220 into slots 512 when installing collection tray 220 to housing 102.

In some non-limiting embodiments or aspects, to remove collection tray 220 (e.g., for emptying and/or cleaning collection tray 220), the user may first remove mixing vessel 104 and the attached dispenser assembly 108 (see FIG. 1). The user may then remove collection tray 220 by pulling collection tray 220 toward the user. This movement may cause collection tray 220 to slide along slots 512 until collection tray 220 is completely disengaged from housing 102. Conversely, to insert collection tray 220 into housing 102, the user may insert collection tray 220 into housing 102 by inserting collection portion 502 into slots 512 underneath evaporator 202 (see FIG. 2) such that evaporator-facing surface 506 faces evaporator 202. In some non-limiting embodiments or aspects, after collection tray 220 has been inserted into housing 102, mixing vessel 104 with attached dispenser assembly 108 may be inserted onto housing 102 and fastened and sealed against housing 102.

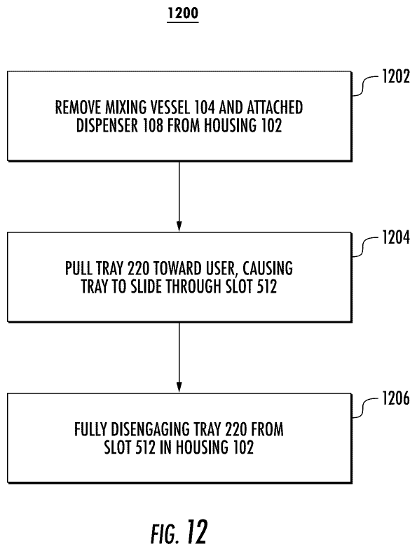

Referring now to FIG. 12, shown is a flow diagram illustrating a method of removing collection tray 220 from housing 102, as described above.

As shown in FIG. 12, the method includes, at step 1202, removing mixing vessel 104 and attached dispenser assembly 108 from housing 102.

As shown in FIG. 12, the method includes, at step 1204, pulling collection tray 220 toward the user, causing collection tray 220 to slide through slot 512.

As shown in FIG. 12, the method includes, at step 1206, fully disengaging collection tray 220 from slot 512 in housing 102.

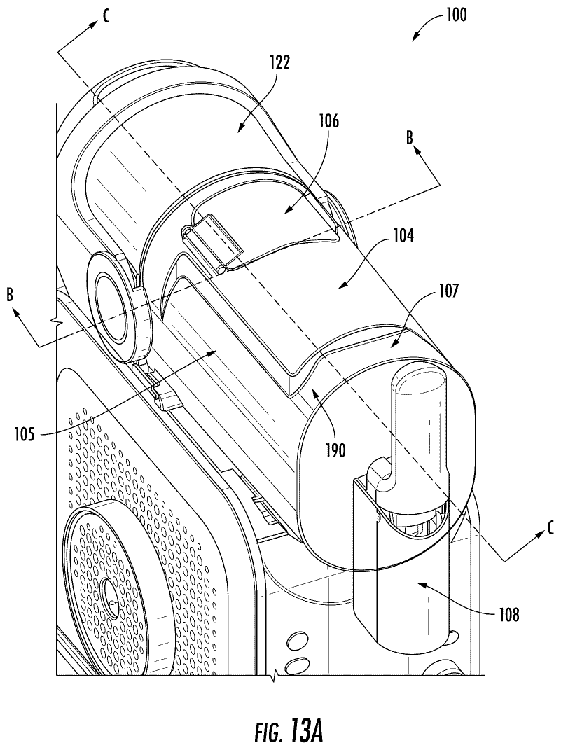

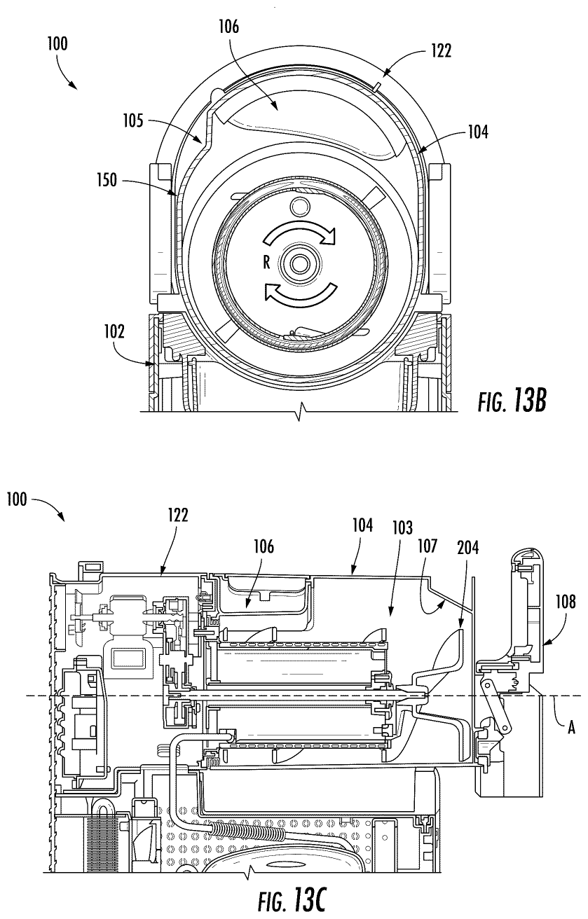

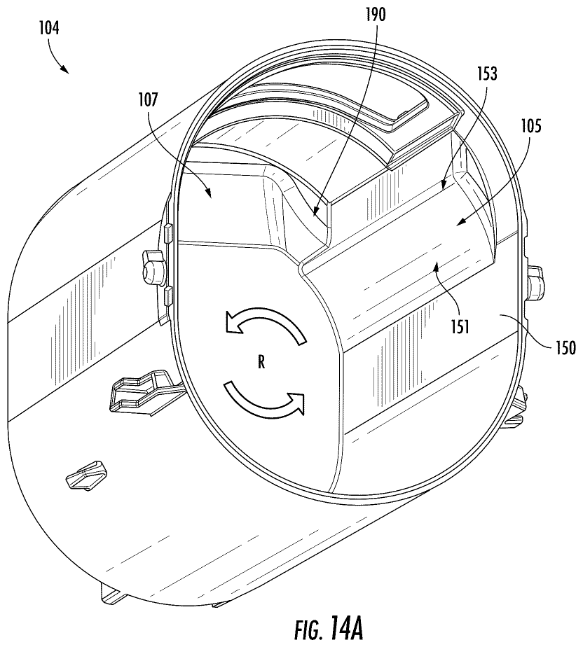

As shown in FIGS. 13A-13C, shown is drink maker 100 with mixing vessel 104 coupled to housing 102 (e.g., coupled to upper housing section 122) and dispenser assembly 108, according to some non-limiting embodiments or aspects. Mixing vessel 104 may have a curved sidewall defining a substantially cylindrical chamber within. In some non-limiting embodiments or aspects, mixing vessel 104 may be shaped as an ovoid or approximately as an ovoid (e.g., a cylinder with an ovular cross-section), or as an elliptic cylinder (e.g., a cylinder with an elliptic cross-section), or an approximate elliptic cylinder, or as a stadium. When coupled to housing 102, the front of mixing vessel 104 may contact dispenser assembly 108 and the rear of mixing vessel 104 may abut upper housing section 122. Within mixing vessel 104, the front face of the chamber may have a substantially ovular, circular, or stadium shape. The rear of mixing vessel 104 chamber may include an opening configured to form a seal with upper housing section 122. The opening at the rear of mixing vessel 104 may have a substantially ovular, circular, or stadium shape. Mixing vessel 104 may be sized to accommodate dasher 204 that rotates about a center axis (shown as center axis “A” in FIG. 13C). FIG. 13B shows a possible direction of dasher 204 rotation (“R”). Mixing vessel 104 may be shaped such that a distance from the center axis (A) of dasher 204 to the top of mixing vessel chamber is less than 6 inches, less than 8 inches, less than 10 inches, less than 12 inches, less than 14 inches, or less than 16 inches.

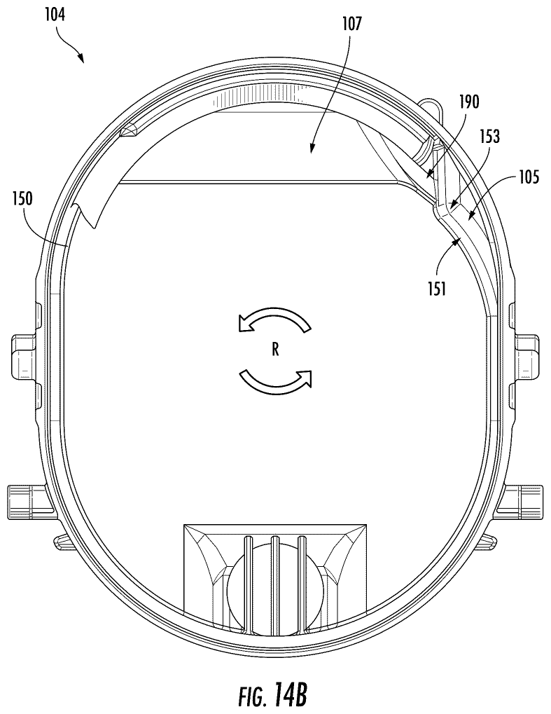

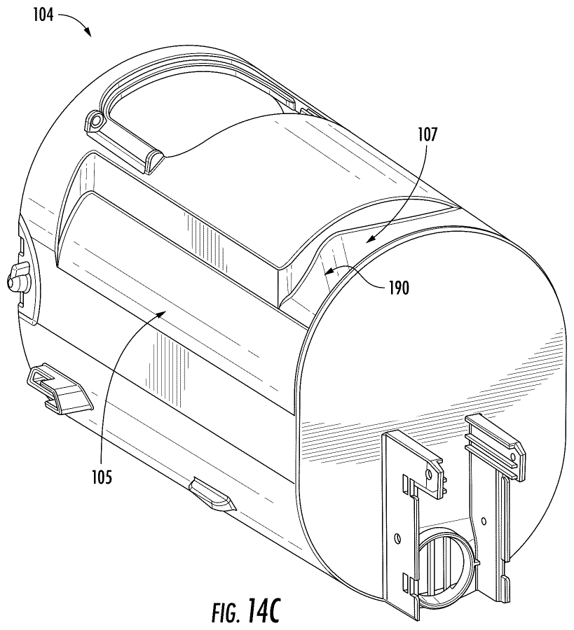

Referring now to FIGS. 14A-14C, shown is mixing vessel 104 with at least one internal baffle configured to control slush flow within mixing vessel 104, according to some non-limiting embodiments or aspects. As shown in FIGS. 13A, 13B, 14A, and 14B, mixing vessel 104 may include a side baffle 105 extending laterally along a sidewall 150 of mixing vessel chamber. In some non-limiting embodiments or aspects, side baffle 105 may extend from the front of mixing vessel chamber (or approximate thereto) to the rear of mixing vessel chamber (or approximate thereto). In some non-limiting embodiments or aspects, side baffle 105 may extend along chamber sidewall 150 in a direction parallel to the center axis (A) of dasher 204. In some non-limiting embodiments or aspects, side baffle 105 may be positioned on a left side (when viewed from the front) of chamber sidewall 150 (e.g., in embodiments in which dasher 204 rotates in a clockwise direction). FIGS. 14A and 14C illustrate a clockwise direction of dasher 204 rotation (R) when viewed from the front. In some non-limiting embodiments or aspects, side baffle 105 may be positioned slightly above the center axis (A) of dasher 204.

In some non-limiting embodiments or aspects, side baffle 105 may include a curved surface 151 that conforms to the pathway of dasher 204, as shown in FIGS. 14A and 14B. For example, when viewed along the center axis (A) of dasher 204, side baffle 105 may protrude inwardly relative the cross-section (e.g., ovular, elliptical, stadium, circular cross-section) of chamber sidewall 150, where, starting from a bottom end of side baffle 105 at which curved surface 151 of side baffle 105 is vertical or substantially vertical, curved surface 151 may slope gradually inward until reaching an inflection point 153. After reaching inflection point 153, curved surface 151 may slope more sharply vertically until the top end of side baffle 105 is reached and, thereafter, curved surface 151 of side baffle 105 may return to a curvature in conformance with the cross-section of chamber sidewall 150. The radial direction of curved surface 151 of side baffle 105 from its bottom to inflection point 153 may be generally aligned with the radial movement of dasher 204 and thus the contents of mixing vessel 104. The cross-sectional geometry of side baffle 105 described above may direct the contents of mixing vessel 104 away from a top of mixing vessel chamber (e.g., at a lower radial trajectory than if side baffle 105 was not present, such as the right side of mixing vessel chamber, as shown in FIG. 13B). If side baffle 105 was not present, contents of mixing vessel chamber could flow unimpeded up sidewall 150 to a top interior surface of mixing vessel chamber, which would leave these contents excluded from mixing and/or allow them to escape from mixing vessel 104. Side baffle 105 thus reduces the amount of frozen material that could otherwise form on the top interior surface of mixing vessel 104 as a result of its contents being rotated upwards.

With further reference to FIGS. 13B, 13C, and 14A-14C, mixing vessel 104 may include a front baffle 107. If present, front baffle 107 may be positioned at a front top portion of mixing vessel chamber 103 (illustrated in FIG. 13B). In some non-limiting embodiments or aspects, front baffle 107 may extend along the front face of mixing vessel chamber 103 between the right sidewall and the left sidewall of mixing vessel chamber 103. The rotation of dasher 204 may push vessel contents towards the front of mixing vessel chamber 103, where, if left unchecked, contents could build up near the top front, perhaps even creating a frozen mass detrimental to the mixing process. Viewed from the cross-section of FIG. 13C, front baffle 107 may form an angle relative the front face of mixing vessel chamber 103 (e.g., 100°-150°, 100°-125°, or 105°-120°), which may redirect vessel contents that have been forced into the top front of mixing vessel 104 towards the rear of mixing vessel chamber 103. In some non-limiting embodiments or aspects, front baffle 107 may include a curved surface extending upwardly from the front face of mixing vessel chamber 103 toward a top of mixing vessel chamber 103. In some non-limiting embodiments or aspects, the angle front baffle 107 formed relative to the front face of mixing vessel chamber 103 may vary from a lower angle (e.g., 5°-20°) at a section of front baffle 107 proximate to the front face of mixing vessel chamber 103 to a higher angle (e.g., 75°-90°) at a section of front baffle 107 proximate to the top of mixing vessel chamber 103. In some non-limiting embodiments or aspects, front baffle 107 may be configured to urge contents away from the top surface of mixing vessel chamber 103 to avoid buildup and overflow on the top of mixing vessel 104. Front baffle 107, thus, may reduce the amount of frozen material that could otherwise form on the top front interior surface of mixing vessel 104 as a result of the action of dasher 204.

With further reference to FIGS. 13C and 14A-14C, mixing vessel 104 may include a corner baffle 190. Corner baffle 190 may be positioned at a front top side of mixing vessel chamber 103. Corner baffle 190 may join or connect side baffle 105 and front baffle 107. Thus, if side baffle 105, front baffle 107, and corner baffle 190 are each present, corner baffle 190 may physically join side baffle 105 to front baffle 107. As shown in FIGS. 14A and 14B, side baffle 105 and front baffle 107 may be orthogonal to each other and if these baffles terminated in a hard corner without a corner baffle 190, slush may not be properly directed. Connecting side baffle 105 and front baffle 107 with corner baffle 190 allows slush to easily flow out of the corner between side baffle 105 and front baffle 107.

In some non-limiting embodiments or aspects, corner baffle 190 may have a curved surface 155 that extends from side baffle 105 to front baffle 107. Curved surface 155 may be convex, as shown in FIG. 14A. Along its length, corner baffle 190 may extend into mixing vessel chamber 103 at a relatively constant distance. In other words, the depth of corner baffle 190 may be relatively constant along the length of corner baffle 190. The side of mixing vessel chamber 103 in which corner baffle 190 is positioned (e.g., the left side or the right side) may be selected based on the direction in which dasher 204 rotates within mixing vessel 104. In particular, corner baffle 190 may be positioned such that dasher 204 is directed toward corner baffle 190 while moving upwardly within mixing vessel chamber 103. In some non-limiting embodiments or aspects, corner baffle 190 may be positioned at the left top front of mixing vessel chamber 103 when dasher 204 is arranged to rotate in a clockwise direction. This positioning may advantageously force slush downward toward dasher 204 when it contacts corner baffle 190 as the slush moves upwardly with dasher 204, thereby reducing slush buildup on the sidewall and the top of mixing vessel 104.

In some non-limiting embodiments or aspects, mixing vessel 104 may include one, two, three, or more internal baffles positioned within mixing vessel chamber 103. In other words, mixing vessel 104 may include side baffle 105, front baffle 107, and/or corner baffle 190. Side baffle 105, front baffle 107, and/or corner baffle 190 may reduce slush buildup on the sidewalls and top of mixing vessel chamber 103, which is important for commercial drink makers as well as household drink makers with significantly less headspace than commercial units.

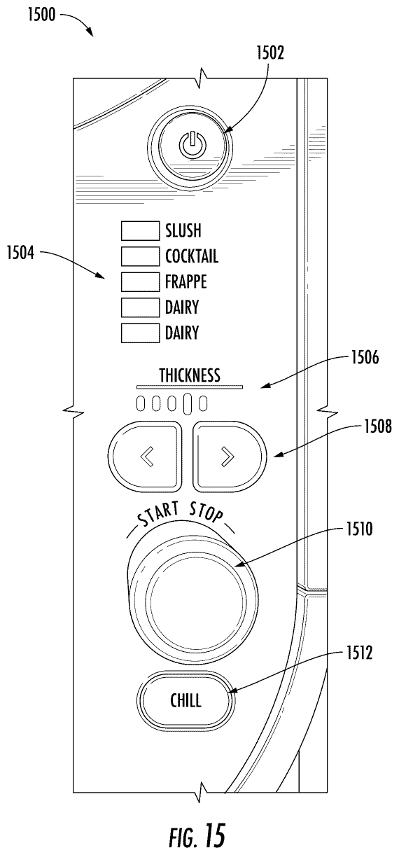

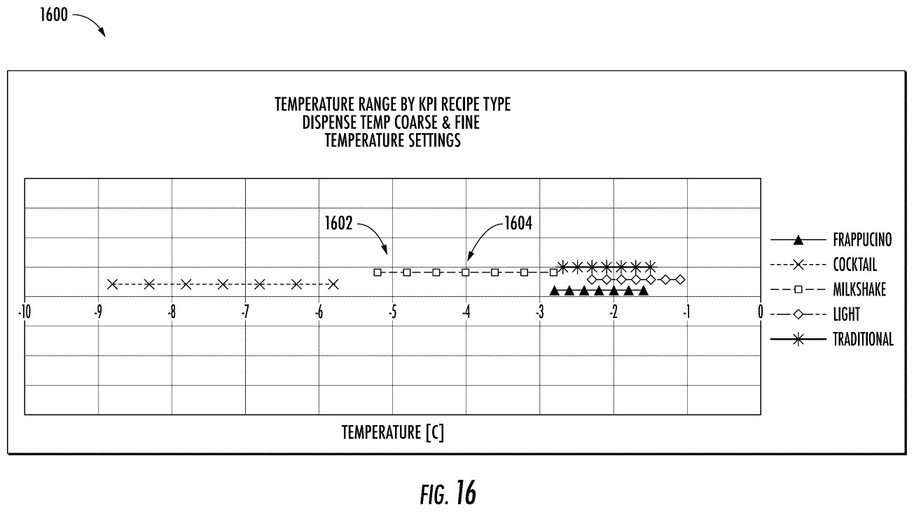

Referring now to FIG. 15, shown is a close-up view 1500 of a user interface (e.g., user interface 112), according to some non-limiting embodiments or aspects. As shown in view 1500, user interface 112 may include a power button 1502, drink type indicator panel 1504, manual temperature adjustment and/or temperature offset indicator 1506, a manual temperature adjustment interface 1508, a drink type control dial 1510, and a chill button 1512. A user may turn drink maker 100 on or off using power button 1502. A user may select a drink type to process a type of drink product by turning dial 1510 until a selected drink type is indicated via panel 1504. The user may select, for example, a slush, a cocktail, a frappé, a juice, or a dairy/milkshake drink type. Dial 1510 may also include a push button feature that enables a user to start or stop processing of a drink type by pressing dial 1510. Manual temperature adjustment interface 1508 may include left and right buttons that enable a user to adjust a temperature within a temperature offset band (e.g., such as temperature offset band 1602 of FIG. 16, for a dairy/milkshake drink type). A user may select chill button 1512 to initiate a chill program whereby drink maker 100 and/or controller 402 maintain the drink product within mixing vessel 104 at a cool temperature without forming a frozen or semi-frozen drink product. In some non-limiting embodiments or aspects, the same cool temperature may be maintained for any drink type when a user selects chill button 1512. For example, controller 402 may receive a signal indicative of the selection of chill button 1512, and reduce the temperature to, and maintain the temperature at or near, a predefined temperature (e.g., in a range) that should not result in any drink type freezing. In another embodiment, controller 402 may receive a signal indicative of the selection of chill button 1512 and a selection of a drink type from drink type control dial 1510, and reduce the temperature to, and maintain the temperature at or near, a predefined temperature (e.g., in a range) defined for that particular drink type (e.g., as specified by a drink data object in memory) that should not result in that drink type freezing.

Referring now to FIG. 16, shown is a graph 1600 of coarse and fine temperature settings for control of a drink maker (e.g., drink maker 100), according to some non-limiting embodiments or aspects. The coarse and fine temperature settings may be associated with processing a drink product, where such temperature settings may be stored as temperature values in memory, as described elsewhere herein. For example, when a user selects a dairy and/or milkshake drink type and starts a frozen drink processing sequence and/or program using dial 1510, controller 402 may control processes of the dairy/milkshake program to adjust the temperature of the drink product to a coarse temperature setting 1604 at −4 degrees Celsius, as shown in graph 1600. Thus, absent any temperature adjustment specified by the user, coarse temperature setting 1604 may serve as the target temperature value, e.g., the temperature value that controller 402 may attempt to attain and maintain during processing of the drink product. A user before, during, or after coarse temperature setting 1604 is reached, may fine tune or adjust the coarse target temperature of the drink type by setting a temperature offset using manual temperature adjustment interface 1508. For example, the user may push the left-arrow button to decrease the target temperature in increments of about 0.4 degrees Celsius, to a new target temperature of about −5.2 degrees Celsius. As the temperature decreases, the thickness and/or amount of frozen drink particles may increase. Hence, manual temperature adjustment indicator 1506 may be associated with a “thickness” label. It will be appreciated that different labels may be used, such as “temperature offset”, “temperature adjust”, “manual adjust”, and the like.

To further illustrate, the user may push the right-arrow button to increase the target temperature, for example, in increments of about 0.4 degrees Celsius, to a new target temperature of about −2.8 degrees Celsius. As the temperature increases, the thickness and/or amount of frozen drink particles may decrease. Manual temperature adjustment indicator 1506 may include one or more light indicators that are illuminated in a configuration corresponding to the selected temperature offset. For example, manual temperature adjustment indicator 1506 may have a center light indicator that indicates that a 0-degree Celsius offset is selected (e.g., no offset). Manual temperature adjustment indicator 1506 may include light indicators corresponding to each increment of offset selected above or below the coarse setting (e.g., the 0-degree Celsius offset point). FIG. 16 also shows temperature offset and/or manual adjustment bands associated with various illustrative types of drink products, such as milkshake, frappuccino, cocktail, light, and traditional. Each of the temperature bands may include a center, coarse, and/or target drink type temperature and user-selectable fine tune offset temperatures above and below the drink type target temperature. In some non-limiting embodiments or aspects, the temperature offset band associated with one drink type may be different than the temperature offset band of a different drink type, resulting in the temperature offset increments being different between the different drink types.

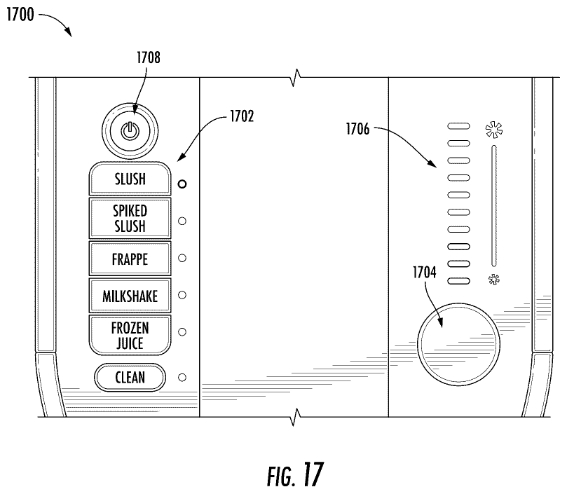

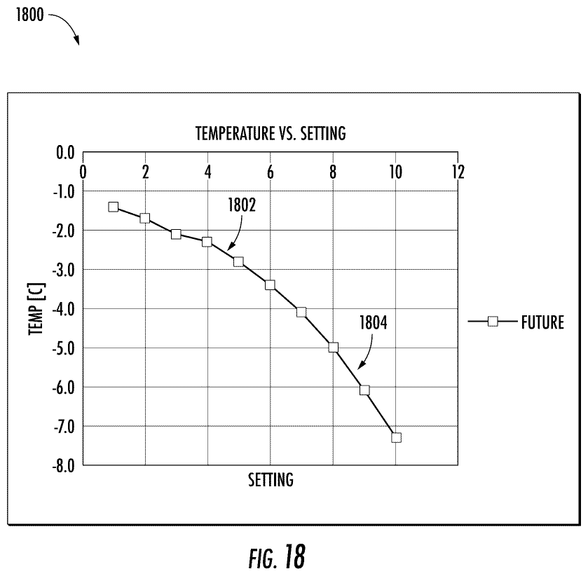

Referring now to FIG. 17, shown is a close-up view 1700 of a user interface (e.g., user interface 112) of a drink maker (e.g., drink maker 100), according to some non-limiting embodiments or aspects. As shown in view 1700, user interface 112 may include a power button 1708, drink type selector/indicator panel 1702, manual temperature adjustment or offset indicator 1706, and a manual temperature adjustment dial 1704. A user may turn drink maker 100 on or off using power button 1708. A user may select a drink type to process a type of drink product by pressing a button associated with a selected drink type, e.g., slush. The selection of a particular drink type may be indicated by illumination of a light indicator associated with the selected drink type button. For example, FIG. 17 shows that the slush drink type has been selected by illumination of the LED indicator next to the slush button. The user may select, for example, a slush drink, spiked slush drink or cocktail, a frappé, a frozen juice, or a dairy/milkshake drink type. Manual temperature adjustment dial 1704 may be rotated clockwise or counter-clockwise to set the target temperature value within a universal range of target temperature values. For example, manual temperature adjustment indicator 1706 may include 10 temperature values or settings corresponding to target temperatures temperature values (see, e.g., FIG. 18)

Referring now to FIG. 18, shown is a graph 1800 of temperature values associated with automatic program temperature target temperatures and manual temperature adjustments, according to some non-limiting embodiments or aspects. Graph 1800 shows temperature settings #1 through #10, where setting #1 may correspond to −1.3 degrees Celsius and setting #10 may correspond to −7.2 degree Celsius. The ten temperature settings of graph 1800 may correspond to the ten light indicators of manual temperature adjustment indicator 1706 (see FIG. 17). In operation, when a user selects a drink type, e.g., milkshake, by pressing the corresponding button in drink type selector/indicator panel 1702, the button's adjacent indicator may illuminate. By way of further example, if the automatic coarse temperature value (e.g., base target temperature value) associated with a milkshake is about −4.0 degrees Celsius, which corresponds to setting #7 in graph 1800, then seven indicators (e.g., light bars) may be illuminated in manual temperature adjustment indicator 1706. The light bars may be dimmed or flash periodically until the target temperature value is reached and/or detected by controller 402. User interface 112 may emit an audible sound, e.g., a beep or beep sequence when a target temperature value is reached. A dimmed or flashing illumination may be changed to a brighter and/or steady illumination when a target temperature value is reached. In some non-limiting embodiments or aspects, once a target temperature value is reached, controller 402 may cycle compressor 214 on and off to keep a temperature of the drink product within a target temperature range above and/or below the target temperature value. For example, the range may be greater than or equal to about 0.2, 0.3, 0.5, or 1.0 degrees Celsius above and below the target temperature value. As long as the temperature remains within the target temperature range, controller 402 may not initiate an alert (e.g., audible output) or change in status of any indicators of manual temperature adjustment indicator 1706.

With further reference to FIGS. 17 and 18, if the user wants to further decrease the target temperature and/or increase the target thickness of the milkshake to setting #10 of FIG. 18, the user may turn dial 1704 until all 10 light indicators are illuminated. If the user wants to increase the target temperature to setting #3 of FIG. 18 and/or reduce the target thickness of the milkshake, the user may turn dial 1704 until three indicators bars of manual temperature adjustment indicator 1706 are illuminated as illustrated in FIG. 17. While FIG. 17 shows an interface using a dial 1704 to manually adjust temperature, other types of interfaces may be used such as, without limitation, up/down buttons, a touch screen, a slider switch, and/or the like.

With further reference to FIG. 18, graph 1800 also illustrates how each increment of temperature change between each of the temperature settings #1 to #10 may be nonlinear to account for adequate changes in thickness of a cooled or frozen drink product. As temperature decreases, a larger change in temperature may be required to cause a material and/or proportional change in the amount of frozen drink particles within the drink product. For example, temperature increment 1802 (between settings #4 and #5) is about 0.6 degrees Celsius, while temperature increment 1804 (between setting #8 and #9), in a lower temperature range, is about −1.0 degrees Celsius. In some non-limiting embodiments or aspects, the increment of temperature change between settings may be constant, resulting a linear temperature range. It will be appreciated that while a range including 10 temperature settings is illustrated in FIGS. 17 and 18, any number of settings and/or temperature ranges may be implemented.

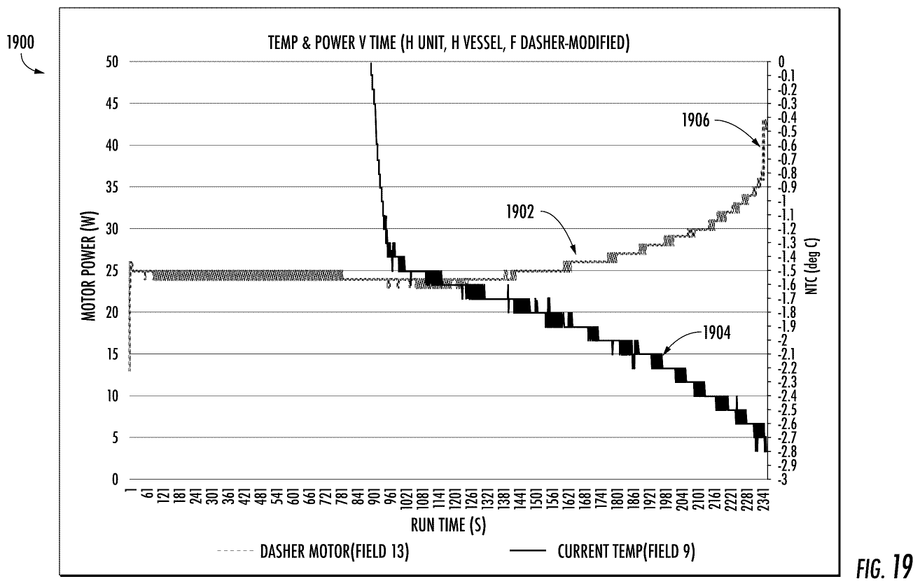

Referring now to FIG. 19, shown is a graph 1900 of drive motor 208 current and temperature of a drink product over time as the drink product is being processed by a drink maker, according to some non-limiting embodiments or aspects. Graph 1900 shows changes in current 1902 for drive motor 208 and corresponding drink product temperatures 1904 over time as a drink product is being processed. Graph 1900 illustrates how the current 1902 applied to drive motor 208 increases as drink product temperature 1904 decreases, causing the thickness of the drink product to increase, which results in an increased resistance of the drink product to the rotation of dasher 204, which, in turn, requires increased motor power and/or current 1902 to drive dasher 204 against the resistance. When current 1902 (or power, torque, etc.) reaches or satisfies a threshold or motor condition limit 1906 (e.g., about 40 Watts and/or about 0.3 amps current), controller 402 may deactivate the cooling circuit (e.g., stop coolant and/or refrigerant flow to evaporator 202) to allow drink product temperature 1904 to increase and reduce the thickness of the drink product, to thereby reduce the current 1902 of drive motor 208 to below motor condition limit 1906.

For example, the base target temperature value of each drink type, and permissible offsets enabled by user interface 412, may be predefined to produce a target temperature corresponding to a motor current 1902 (or power, torque, etc.) that is safely below a motor condition limit 1906. Controller 402 may automatically control the temperature of the drink product in mixing vessel 104 to attain the base target temperature setting associated with the user-selected drink type, which may be adjusted (e.g., fine-tuned) by an offset corresponding to a user-selected temperature adjustment and/or temperature offset, to a new temperature setting (e.g., the target temperature value), at which temperature the magnitude of motor current 1902 may be lower than the motor condition limit 1906. The target temperature may be set to be, for example, 0.25, 0.5, 0.75, 1, 1.25, 1.5, or 2.0 degrees Celsius above (e.g., by a relatively small offset) the base target temperature. However, it is possible that the ingredients put into mixing vessel 104 may result in a drink product that results in ice build-up during processing, such that motor condition limit 1906 is exceeded. For example, if there is insufficient sugar and/or alcohol content in the drink product, ice may form at a higher (e.g., warmer) temperature than expected and be more difficult for dasher 204 to scrape from a surface of evaporator 202. By deactivating the cooling circuit, if the motor condition limit 1906 is exceeded, controller 402 may prevent an overcurrent condition and possible damage to drive motor 208, avoid a stall condition, and enable operation of drink maker 100 and dasher 204 to continue. Otherwise, drive motor 208 may stall and drink maker 100 may become jammed up, blocking slush output from mixing vessel 104 and requiring a user to defrost and/or unblock mixing vessel 104 before normal operations may be resumed. Hence, the stall prevention described herein may enable drink maker 100 to produce and output slush and other outputs that it otherwise would not be able to do if a stall condition occurred. Further, an excessive current (or power, torque, etc.) condition of drive motor 208 caused by an object (e.g., excessive ice formation) blocking rotations of dasher 204 may also be prevented.

Controller 402 may perform actions in addition to stopping drive motor 208, such as shutting down compressor 214 to deactivate the cooling circuit. Graph 1900 also shows how controller 402 may continuously and/or periodically monitor temperature associated with a drink product within mixing vessel 104 via temperature sensor(s) 406 to enable continuous control of components such as compressor 214, and other components, of drink maker 100 to enable automatic control of the temperature of a drink product.

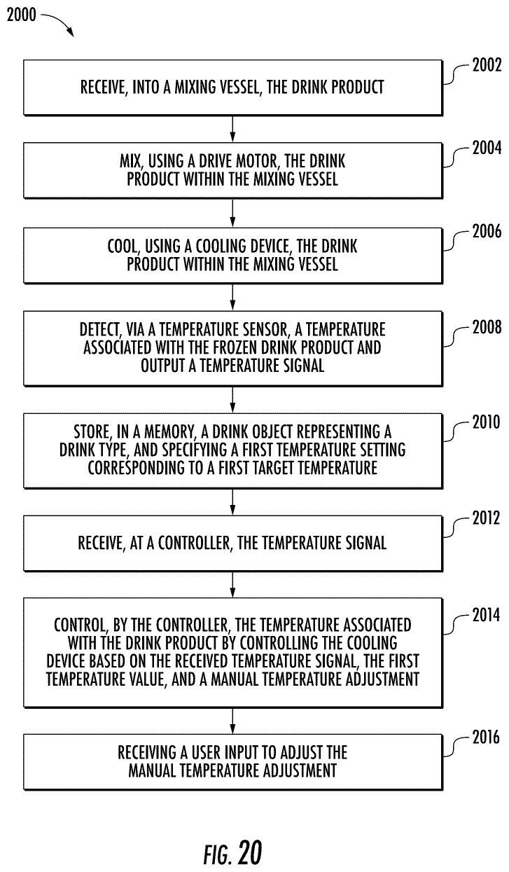

Referring now to FIG. 20, shown is a flow diagram of a method 2000 for processing a drink product in a drink maker, according to some non-limiting embodiments or aspects. The steps shown in FIG. 20 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 2000 includes steps for making a cooled drink product using a program for initial or coarse temperature and/or texture control and then using a user input to fine tune the temperature and/or texture of the drink product.

As shown in FIG. 20, method 2000 may include, at step 2002, receiving, into mixing vessel 104 of drink maker 100, a drink product. For example, a user may pour a drink product into pour-in opening 106 of mixing vessel 104 to fill mixing vessel 104, at least partly, with the drink product. When pouring is complete, the user may close pour-in opening 106.

As shown in FIG. 20, method 2000 may include, at step 2004, mixing, using drive motor 208, the drink product within mixing vessel 104. For example, a user may interact with user interface 112 and select a power button, temperature setting, drink product type, and/or a chill button to cause controller 402 to initiate a mixing process. Controller 402 may cause drive motor 208 to turn dasher 204 within mixing vessel 104 to mix the drink product.

As shown in FIG. 20, method 2000 may include, at step 2006, cooling, using a cooling device (e.g., a cooling circuit), the drink product within mixing vessel 104. For example, controller 402 may cause compressor 214 to turn on, causing refrigerant to circulate through the cooling circuit, reducing a temperature in evaporator 202. As the drink product is mixed by dasher 204, the drink product may come into contact with evaporator 202 (e.g., a drum thereof), thereby cooling the drink product.

As shown in FIG. 20, method 2000 may include, at step 2008, detecting, via temperature sensor(s) 406, a temperature associated with the drink product and output a temperature signal. For example, a temperature sensor 406 positioned in the front of mixing vessel 104 (e.g., on a front, lower end of a drum of evaporator 202), may periodically detect temperatures associated with the mixing drink product, and may generate temperature signals based on each respectively detected temperature.

As shown in FIG. 20, method 2000 may include, at step 2010, storing, in memory 404, a drink data object representing a drink type and specifying a first temperature setting corresponding to a first target temperature. For example, controller 402 may cause a drink data object to be stored in memory 404 of drink maker 100, where the drink data object represents a drink type, and where the drink data object specifies a first temperature setting corresponding to a first target temperature. In some non-limiting embodiments or aspects, step 2010 may be performed before step 2002. The user may select an operational setting of drink maker 100 via user interface 112 that is associated with a drink data object.

As shown in FIG. 20, method 2000 may include, at step 2012, receiving, at controller 402, the temperature signal. For example, one or more of the periodic temperature signals generated by temperature sensor(s) 406 in step 2008 may be output to, and received by, controller 402. Controller 402 may be configured to interpret the temperature signal as being associated with a temperature, and controller 402 may further control drink maker 100 based on the temperature signals.

As shown in FIG. 20, method 2000 may include, at step 2014, controlling, by controller 402, the temperature associated with the drink product by controlling the cooling device (e.g., cooling circuit) based on the received temperature signal, a first temperature value, and a manual temperature adjustment. For example, controller 402 may control the on/off state of compressor 214 to control the cooling circuit. Controller 402 may control the cooling circuit to achieve and maintain a temperature in the drink product based on the first temperature value that is associated with the stored drink data object (e.g., to bring the detected temperature of the drink product down to, and around the first temperature value). If the user of drink maker 100 inputs any manual temperature adjustments (e.g., upward or downward increments of temperature in user interface 112), controller 402 may target a temperature for the drink product that is the first temperature value plus a positive or negative offset that corresponds to the manual temperature adjustment.

As shown in FIG. 20, method 2000 may include, at step 2016, receiving a user input to adjust the manual temperature adjustment. For example, controller 402 may receive, via user interface 112, one or more user inputs to the manual temperature adjustment. Controller 402 may then modify an offset to a target temperature based on the user's input. Step 2016 may be performed before, during, or after the drink product begins mixing and/or cooling in mixing vessel 104.

In some non-limiting embodiments or aspects, the user input may be indicative of a desired thickness corresponding to the manual temperature adjustment. In some non-limiting embodiments or aspects, the manual temperature adjustment may be customized per drink type. In some non-limiting embodiments or aspects, the manual temperature adjustment may be universal for all drink types. In some non-limiting embodiments or aspects, the manual temperature adjustment may be finer and/or for a smaller range specific to a drink type (e.g., corresponding to FIG. 16), or may be coarser and/or for a larger range not specific to a drink type (e.g., spanning multiple or all drink types), thereby enabling a user greater latitude in adjusting thickness and/or temperature.

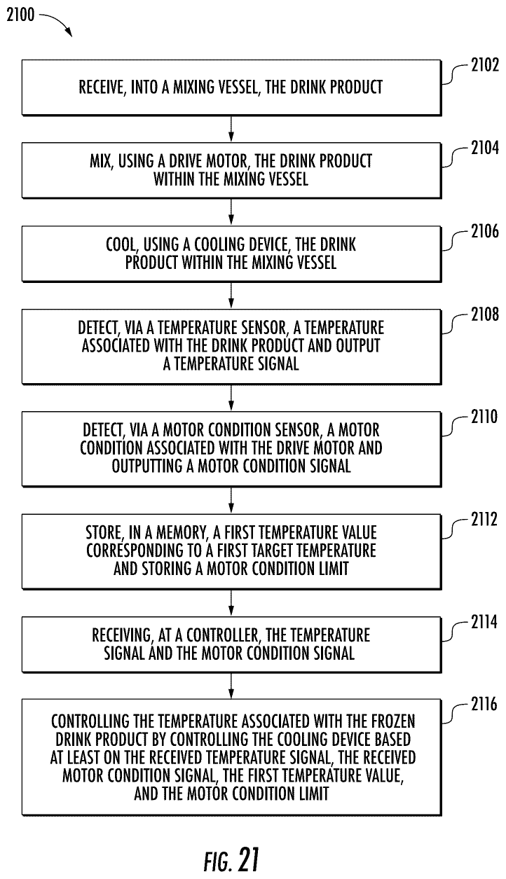

Referring now to FIG. 21, shown is a flow diagram of a method 2100 for processing a drink product in a drink maker, according to some non-limiting embodiments or aspects. The steps shown in FIG. 21 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step. As shown, method 2100 includes steps for automatically detecting when drive motor 208 current (e.g., current through drive motor 208) is too high (e.g., as a result of a drink product being too thick and/or an ice formation on evaporator 202 surface) and, in response, adjusting the temperature of the drink product to reduce drive motor 208 current, to thereby reduce a thickness of the drink product and/or thaw an ice block.

As shown in FIG. 21, method 2100 may include, at step 2102, receiving, into mixing vessel 104 of drink maker 100, a drink product. For example, a user may pour a drink product into pour-in opening 106 of mixing vessel 104 to fill mixing vessel 104, at least partly, with the drink product. When pouring is complete, the user may close pour-in opening 106.

As shown in FIG. 21, method 2100 may include, at step 2104, mixing, using drive motor 208, the drink product within mixing vessel 104. For example, a user may interact with user interface 112 and select a power button, temperature setting, drink product type, and/or a chill button to cause controller 402 to initiate a mixing process. Controller 402 may cause drive motor 208 to turn dasher 204 within mixing vessel 104 to mix the drink product.

As shown in FIG. 21, method 2100 may include, at step 2106, cooling, using a cooling device (e.g., a cooling circuit), the drink product within mixing vessel 104. For example, controller 402 may cause compressor 214 to turn on, causing refrigerant to circulate through the cooling circuit, reducing a temperature in evaporator 202. As the drink product is mixed by dasher 204, the drink product may come into contact with evaporator 202 (e.g., a drum thereof), thereby cooling the drink product.

As shown in FIG. 21, method 2100 may include, at step 2108, detecting, via temperature sensor(s) 406, a temperature associated with the drink product and output a temperature signal. For example, a temperature sensor 406 positioned in the front of mixing vessel 104 (e.g., on a front, lower end of a drum of evaporator 202), may periodically detect temperatures associated with the mixing drink product, and may generate temperature signals based on each respectively detected temperature.

As shown in FIG. 21, method 2100 may include, at step 2110, detecting, via motor condition sensor(s) 406, a motor condition associated with drive motor 208 and outputting a motor condition signal. For example, a motor condition sensor 406 configured to measure one or more motor conditions of drive motor 208 (e.g., motor current, power, torque, etc.) may periodically detect a motor condition associated with drive motor 208, and may generate motor condition signals based on each respectively detected motor condition.

As shown in FIG. 21, method 2100 may include, at step 2112, storing, in memory 404, a first temperature value corresponding to a first target temperature and storing a motor condition limit. For example, controller 402 may cause a first temperature value and a motor condition limit to be stored in memory 404 of drink maker 100, where the first temperature value corresponds to a first target temperature, and the motor condition limit (e.g., threshold) corresponds to a motor condition, such as, but not limited to, current, power, torque, and/or the like.

As shown in FIG. 21, method 2100 may include, at step 2114, receiving, at controller 402, the temperature signal and the motor condition signal. For example, one or more of the periodic temperature signals generated by temperature sensor(s) 406 in step 2108 may be output to, and received by, controller 402. Moreover, one or more of the periodic motor condition signals generated by motor condition sensor(s) 406 in step 2110 may be output to, and received by, controller 402.

As shown in FIG. 21, method 2100 may include, at step 2116, controlling, by controller 402, the temperature associated with the drink product by controlling the cooling device (e.g., cooling circuit) based on the received temperature signal, the received motor condition signal, a first temperature value, and a motor condition limit. For example, controller 402 may control the on/off state of compressor 214 to control the cooling circuit. Controller 402 may control the cooling circuit to achieve and maintain a temperature in the drink product based on the first temperature value (e.g., to bring the detected temperature of the drink product down to, and around the first temperature value). If the motor condition signal satisfies the motor condition limit (e.g., meets and/or exceeds a threshold motor condition value), controller 402 may cycle compressor 214, pulse drive motor 208, and/or turn off compressor 214 and/or drive motor 208 for a time. Controller 402 may return compressor 214 and/or drive motor 208 to otherwise expected operation in response to the motor condition signal no longer satisfying the motor condition limit.

In some non-limiting embodiments or aspects, controller 402 may stop and/or deactivate drive motor 208 to stop rotation of dasher 204 when the motor condition signal satisfies a motor knockdown threshold (e.g., the motor current, power, or torque is too high and/or high enough to damage drive motor 208, which may be caused by an excessive buildup of ice within mixing vessel 104). Excessive ice buildup may be caused, for example, by filling mixing vessel 104 with only water or a liquid predominantly consisting of water (e.g., not having a high-enough percentage of other ingredients, such as sugar/alcohol), thereby producing ice on the surface of evaporator 202 that is more difficult for dasher 204 to scrape away from the surface of evaporator 202. Shutdown of drive motor 208 may also prevent damage to dasher 204 caused by excessive buildup of hard ice. Controller 402 may perform other actions in addition to deactivating drive motor 208. Additionally, or alternatively, controller 402 may cause an alert to a user, via user interface 112, to add more ingredients (e.g., including sugar or alcohol) to the drink product, to turn off drink maker 100, and/or the like. A different motor shutdown threshold for drive motor 208 may be set higher than the motor knockdown threshold limit. In this way, controller 402 may attempt to increase temperature in mixing vessel 104 when a motor knockdown threshold limit is reached, but only shut down and/or stop drive motor 208 when a motor shutdown threshold is reached, to prevent damage to drive motor 208. Controller 402 may take action based on determining whether the motor knockdown threshold limit or the motor shutdown limit has been reached or exceeded for a period of time, e.g., 0.5, 1.0, 1.5, 2.0, 5 seconds, or more. By observing motor current (or power, torque, etc.) for a period of time, a false positive and/or reading of current (or power, torque, etc.) may be eliminated.

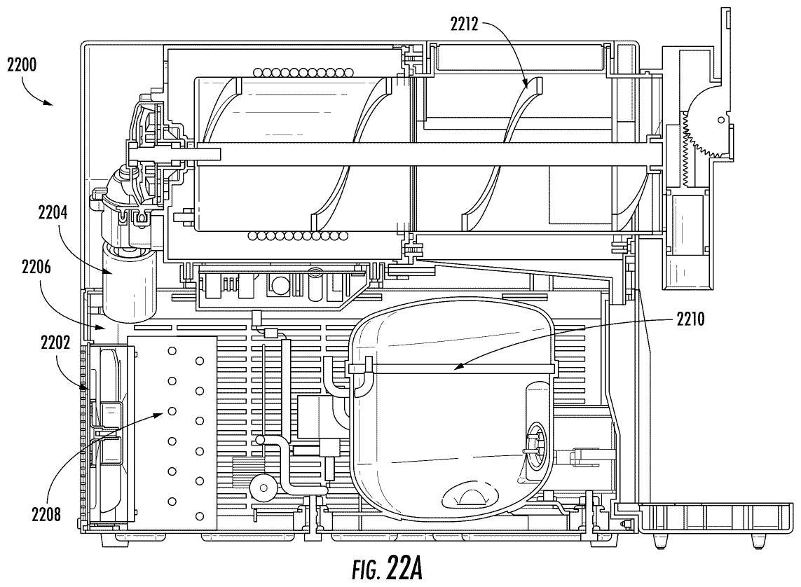

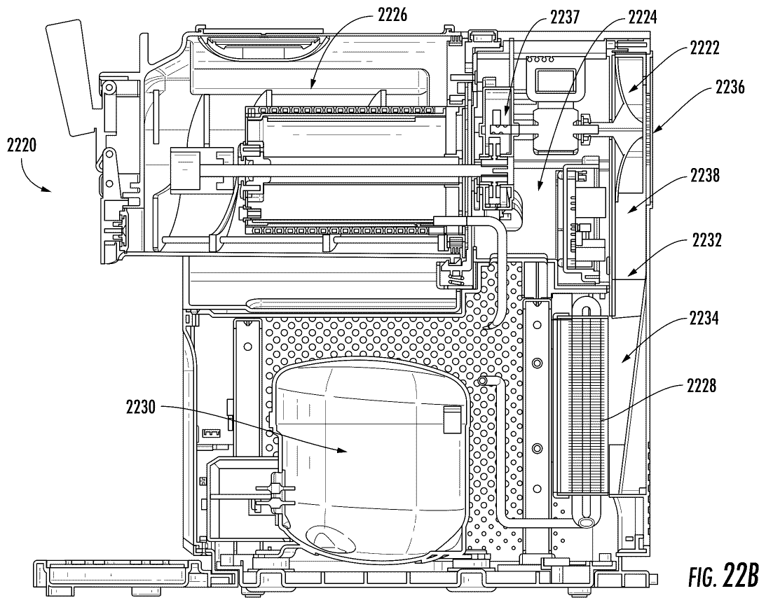

Referring now to FIG. 22A, shown is a dual-use cooling fan 2202 within a housing of a drink maker 2200 (e.g., drink maker 100) including a refrigeration system having a condenser 2208 and compressor 2210. Drink maker 2200 may also include drive motor 2204 configured to drive rotation of dasher 2212 during processing of a drink product. Dual-use cooling fan 2202 may draw an air flow through condenser 2208 and direct the air flow, via a cooling channel 2206, toward drive motor 2204. The air flow may pass over and adjacent to condenser 2208 coils as it passes through condenser 2208 to cool the refrigerant passing through condenser 2208 within a closed loop refrigeration system. The air flow may also pass along a surface and/or surfaces of drive motor 2204 to effect cooling of drive motor 2204. While FIG. 22A shows a configuration where drive motor 2204 and condenser 2208 are positioned at about right angles with respect to dual-use cooling fan 2202, other configurations, arrangements, or orientations may be implemented, such that dual-use cooling fan 2202 provides a cooling air flow to condenser 2208 and drive motor 2204.

In some non-limiting embodiments or aspects, a drink maker, such as drink maker 2200, may include a mixing vessel, like mixing vessel 104, arranged to receive a drink product. Drink maker 2200 may include a mixing component such as dasher 2212 (e.g., dasher 204) or another type of mixing component, driven by drive motor 2204, that is arranged to mix the drink product within mixing vessel 104. A refrigeration system may be arranged to cool the drink product within mixing vessel 104 that includes a condenser, such as condenser 2208. Cooling fan 2202, e.g., a dual-use cooling fan, may be configured to concurrently cool drive motor 2204 and condenser 2208. Cooling fan 2202 may provide air flow through condenser 2208 to cool refrigerant flowing through condenser 2208. Cooling fan 2202 may provide air flow along a surface of drive motor 2204 to cool the drive motor 2204. Cooling fan 2202, drive motor 2204, and condenser 2208 may be positioned such that air generated by cooling fan 2202 passes serially through condenser 2208 and along a surface of the drive motor 2204.

In some non-limiting embodiments or aspects, a first portion of air generated by cooling fan 2202 may cool condenser 2208 and a second portion of air generated by cooling fan 2202 may cool drive motor 2204. Condenser 2208 may include a plurality of coils that carry coolant and/or refrigerant within a closed loop of the refrigeration circuit. When cooling fan 2202 provides air flow through condenser 2208 to cool refrigerant flowing through condenser 2208, the air flow may travel adjacent to and/or around the plurality of coils. A cooling channel 2206 may extend between cooling fan 2202 and drive motor 2204 where cooling channel 2206 provides cooling air flow between cooling fan 2202 and drive motor 2204. Cooling channel 2206 may be at least partially formed by a duct and/or ducting. The ducting may include plastic, metals, composite materials, and the like. Cooling channel 2206 may extend between cooling fan 2202 and condenser 2208, where cooling channel 2206 provides cooling air flow between cooling fan 2202 and condenser 2208. Cooling channel 2206 may be at least partially formed by a duct. Cooling fan 2202 may include a centrifugal fan, a cross-flow fan, a tangential fan, a volute fan, a backward curved fan, a forward curved fan, a blower fan, a squirrel-cage fan, and/or an axial fan.

In some non-limiting embodiments or aspects, a cooling fan, such as cooling fan 2202, may be configured for cooling a drive motor, such as drive motor 2204, and a condenser, such as condenser 2208, within a housing of a drink maker. Cooling fan 2202 may include an air inlet configured to receive an air flow, an impeller configured to generate the air flow, and an air outlet configured to output the air flow through condenser 2208 and along a surface of drive motor 2204.

Referring now to FIG. 22B, shown is a dual-use cooling fan 2222 within the housing of a drink maker 2220 including a drive motor 2224, a dasher 2226, a compressor 2230, and a condenser 2228, according to some non-limiting embodiments or aspects. Drive motor 2224 may be coupled to and may drive rotation of dasher 2226 and may also drive rotation of cooling fan 2222 via gears 2237. Cooling fan 2222 may include an air outlet 2238 that directs air flow from cooling fan 2222 through air channel 2232, which may include ducting 2234 that directs air flow through condenser 2228 to cool refrigerant flowing through condenser 2228.

Referring now to FIG. 22C, shown is a perspective view 2240 of dual-use cooling fan 2222 within housing 2242 of drink maker 2220. Cooling fan 2222 may be a centrifugal fan and/or another type of fan, as described herein. Cooling fan 2222 may include an impeller 2244 that draws air flow into cooling fan 2222 via inlet 2236 and then expels air downward at about a right angle via outlet 2238 with respect to inlet 2236. The air flow exiting outlet 2238 may flow downward past drive motor 2224, including along a surface of drive motor 2224, and through air channel 2232, which may include ducting 2234 that directs the air flow through condenser 2228 (adjacent to and/or around coils of condenser 2228) to effect cooling of refrigerant passing through the coils.

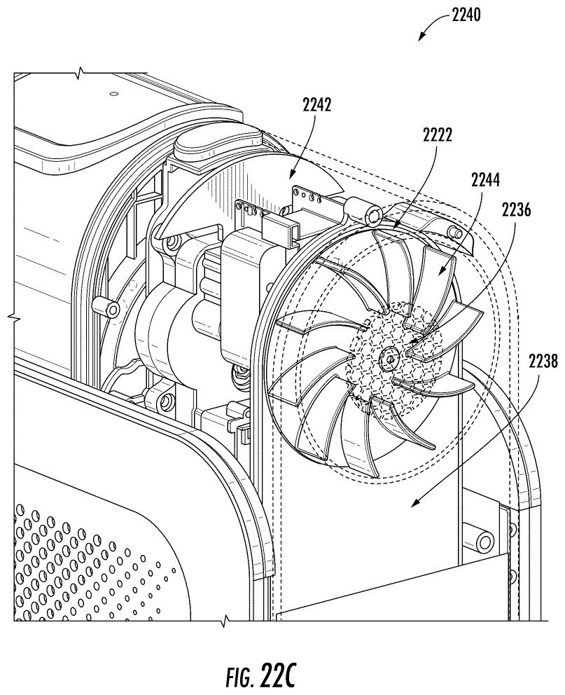

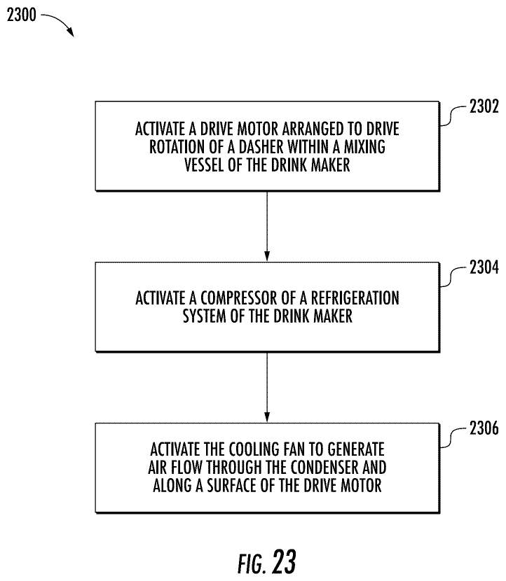

Referring now to FIG. 23, shown is a flow diagram of a method 2300 for operating dual-use cooling fan 2202 or 2222 of FIGS. 22A and 22B, respectively, according to some non-limiting embodiments or aspects. As shown, method 2300 facilitates concurrently cooling condenser 2208 (or condenser 2228) and drive motor 2204 (or drive motor 2224) within a housing of a drink maker using a cooling fan 2202 (or cooling fan 2222).

As shown in FIG. 23, method 2300 may include, at step 2302, activating a drive motor arranged to drive rotation of a dasher within a mixing vessel of the drink maker. For example, step 2302 may include activating drive motor 2204 (or drive motor 2224) arranged to drive rotation of dasher 2212 (or dasher 2226) within mixing vessel (e.g., mixing vessel 104) of a drink maker (e.g., drink maker 100).

As shown in FIG. 23, method 2300 may include, at step 2304, activating a compressor of a refrigeration system of the drink maker. For example, step 2304 may include activating compressor 2210 (or compressor 2230) of a refrigeration circuit of the drink maker.

As shown in FIG. 23, method 2300 may include, at step 2306, activating the cooling fan to generate air flow through the condenser and along a surface of the drive motor. For example, step 2306 may include activating cooling fan 2202 (or cooling fan 2222) to concurrently generate air flow through condenser 2208 (or condenser 2228) and along a surface of drive motor 2204 (or drive motor 2224).

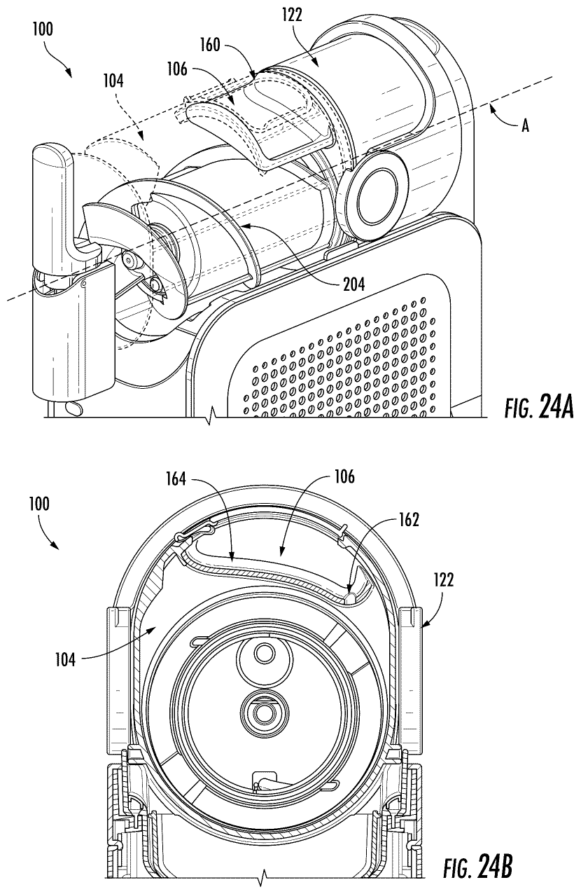

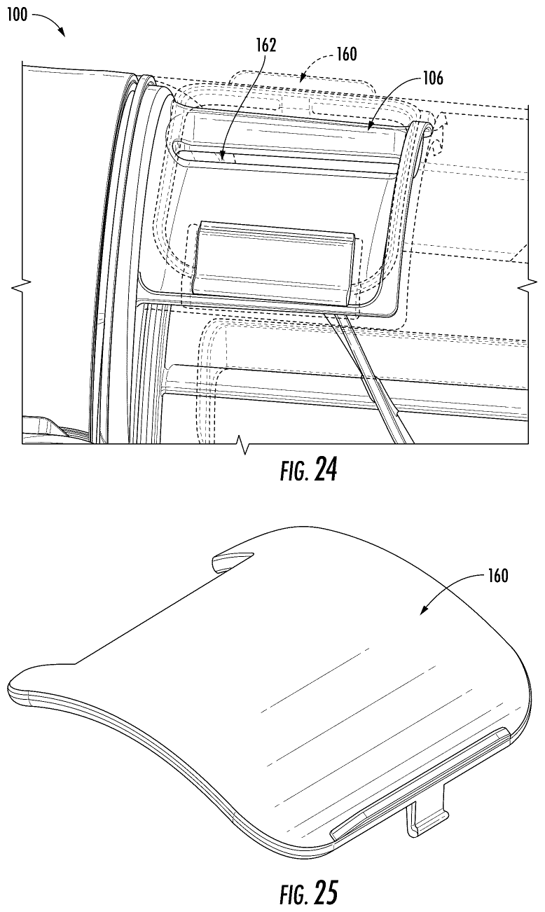

Referring now to FIGS. 24A-24C, shown is pour-in opening 106 for drink maker 100, according to some non-limiting embodiments or aspects. As previously mentioned, drink maker 100 may include pour-in opening 106 through which mixing vessel 104 may receive ingredients to be mixed to produce a drink product. Drink maker 100 may include mixing vessel 104 with a substantially cylindrical chamber and housing 102 with upper housing section 122. FIG. 24A shows a perspective side view of pour-in opening 106. FIG. 24B shows a front view of pour-in opening 106 of FIG. 24A, and FIG. 24C shows a perspective view of pour-in opening 106 of FIG. 24A from the left side of mixing vessel 104 (when viewed from the front view). Pour-in opening 106 may facilitate the addition of fluids, liquids, slush, or other ingredients to mixing vessel 104 while dasher 204 is active, as well as minimizing spillage and preventing finger insertion during use.

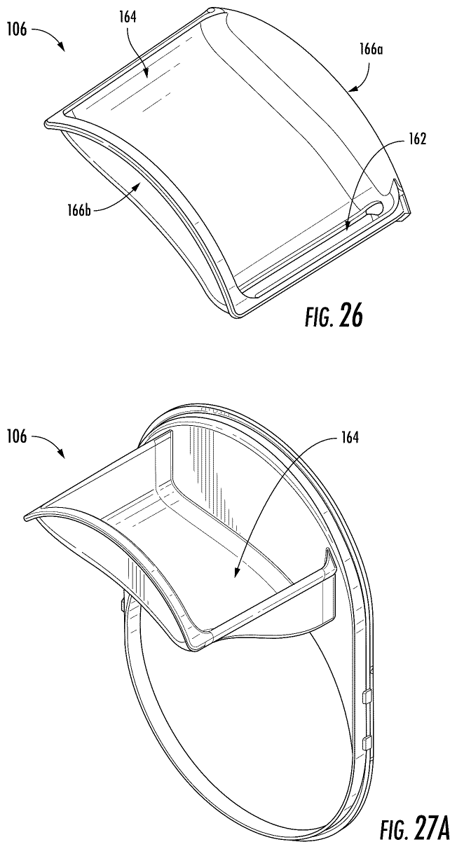

In some non-limiting embodiments or aspects, pour-in opening 106 may include a cover 160 to seal pour-in opening 106, as shown in FIGS. 24A and 24C. A detailed perspective view of cover 160 for pour-in opening 106 is shown in FIG. 25. If present, cover 160 may be hingedly connected to an upper section of mixing vessel 104. Cover 160 may be moved between an open position in which pour-in opening 106 is accessible to a user and a closed position in which pour-in opening 106 is not accessible to a user. Although not illustrated in the accompanying figures, pour-in opening 106 may also include a grate to restrict objects from entering aperture 162. If present, a grate may reduce the risk of solids greater than a certain size and/or having one or more certain shapes entering mixing vessel 104, which may cause damage.

Referring now to FIG. 26, shown is a perspective view of pour-in opening 106, according to some non-limiting embodiments or aspects. Pour-in opening 106 may include a surface 164 that inclines radially with respect to a center axis of dasher 204 (shown as axis “A” in FIG. 24A). Surface 164 may reduce possible splashing as mixing vessel 104 is filled. Surface 164 also may prevent slush contained within mixing vessel 104 from being pushed out of pour-in opening 106. Surface 164 may include aperture 162. In some non-limiting embodiments or aspects, additional apertures may also be present. Aperture 162 may be in fluid communication with an interior chamber of mixing vessel 104. In some non-limiting embodiments or aspects, aperture 162 may extend laterally along surface 164 in a direction parallel to the center axis “A” of dasher 204. Aperture 162 may be shaped as a slot, as shown in FIG. 26, or may have a different shape. If shaped as a slot, aperture 162 may be longer or wider than shown in FIGS. 24A-24C and/or may have a different ratio of length to width than shown. Further, aperture 162, as a slot or another oblong shape, may have its major axis aligned parallel or perpendicular to the axis of mixing vessel 104, or at any other angle relative to the axis of mixing vessel 104. Aperture 162, for example, in the form of a slot, may be sized small enough (at least in width) to not allow passage of a human finger, at least not the entire length of a human finger, to thereby prevent a user from sticking one or more fingers into mixing vessel 104.

In some non-limiting embodiments or aspects, pour-in opening 106 may optionally include one or more lips 166a, 166b extending up from a perimeter of surface 164 to form a well that feeds into aperture 162, as shown in FIG. 26. One or more lips 166a, 166b may reduce overflow spill when a liquid is poured into mixing vessel 104. If desired, pour-in opening 106 may also include a grate (not illustrated) (e.g., a number of parallel and/or overlapping bars) covering at least a portion of aperture 162. For safety concerns, users should not contact dasher 204 while it is rotating. The geometry of pour-in opening 106 (including aperture 162 as described above) may inhibit or prevent a user from reaching into mixing vessel 104 even when cover 160 is in an open position and/or dasher 204 is rotating.

In some non-limiting embodiments or aspects, pour-in opening 106 may be positioned on a top of mixing vessel 104, near its rear end, as shown in FIGS. 24A-24C, opposite dispenser assembly 108. Positioning pour-in opening 106 near the rear of mixing vessel 104 may avoid interference with slush circulation in the front of drink maker 100, which may lead to waste and non-homogeneous texture. With pour-in opening 106 positioned at the rear of mixing vessel 104, the front ⅔ of mixing vessel 104 may have a continuous and smooth internal shape to provide good slush flow and minimize migration of the slush out of the top. By positioning pour-in opening 106 near rear of mixing vessel 104, pour-in opening 106 may be located in a position where there is less possible buildup of frozen and/or slush materials, enabling less obstructed pouring and reducing possible buildup of ice and/or slush material at pour-in opening 106 during processing.

In some non-limiting embodiments or aspects, surface 164 of pour-in opening 106 may be sloped to direct incoming ingredients to enter mixing vessel 104 in an entry direction, which may be the same as the direction of dasher 204 rotation. This may prevent the rotating frozen mixture from exiting mixing vessel 104 through pour-in opening 106. In some non-limiting embodiments or aspects, when dasher 204 is rotating in a clockwise direction when viewed from the front of drink maker 100, pour-in opening 106 may be positioned on the right side of mixing vessel 104. Aperture 162 may be positioned to extend laterally along surface 164 in a direction parallel to the center axis (A) of dasher 204. In some non-limiting embodiments or aspects, when dasher 204 is rotating in a counter-clockwise direction when viewed from the front of the drink maker 100, pour-in opening 106 may be positioned on the left side of mixing vessel 104.

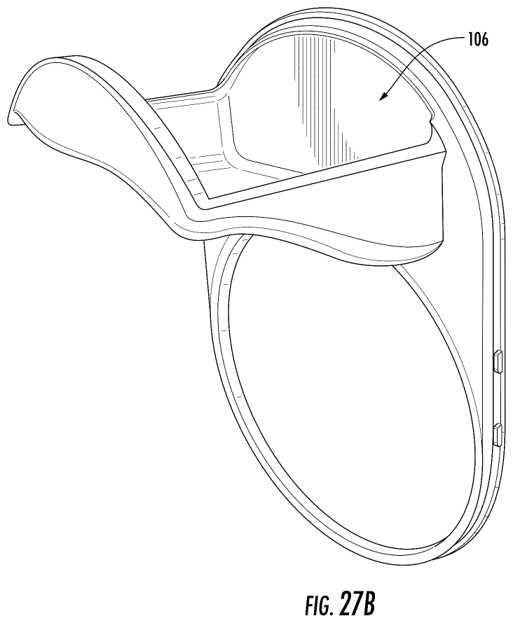

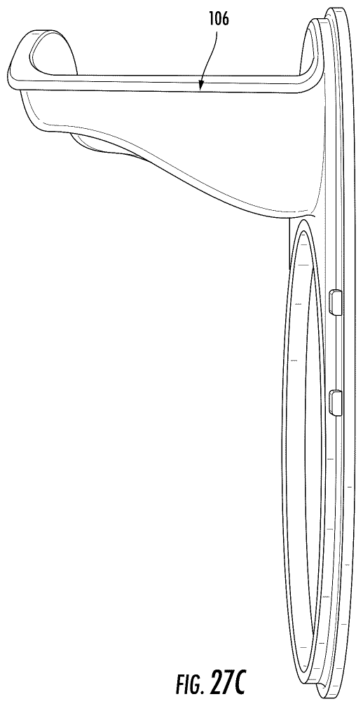

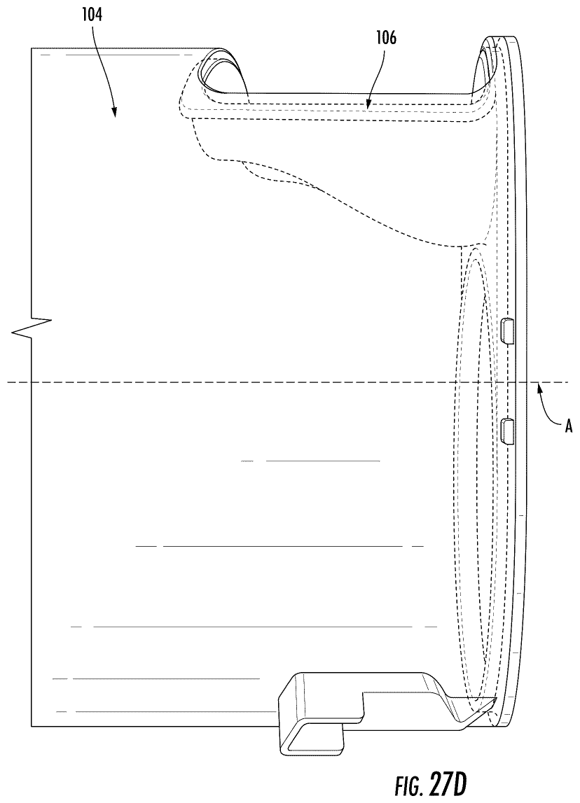

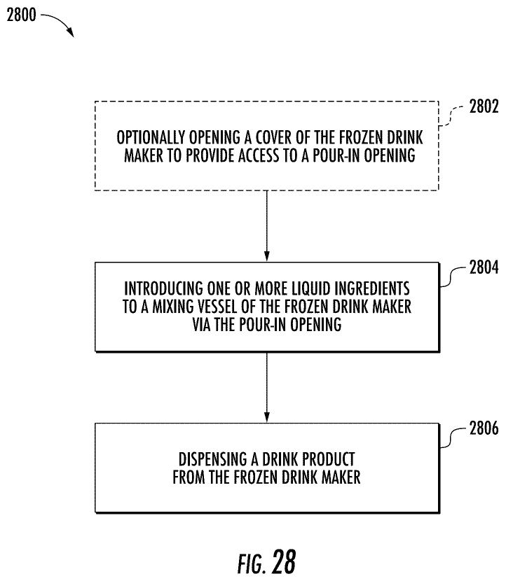

Referring now to FIGS. 27A-27D, shown is pour-in opening 106 in which surface 164 of pour-in opening 106 is shaped to slope downwardly toward a rear of mixing vessel 104, according to some non-limiting embodiments or aspects. For example, one or more apertures 162 may be positioned at a bottom portion of surface 164. Shaping surface 164 to include a rearward slope may increase the volume capacity of pour-in opening 106 and reduce spillage. In some non-limiting embodiments or aspects, in which surface 164 of pour-in opening 106 is sloped relative to the center axis (A) of dasher 204, surface 164 may be shaped such that a section of surface 164 closest to a front of mixing vessel 104 is positioned farther away from the center axis (A) of dasher 204 than a section of surface 164 closest to a rear of mixing vessel 104.

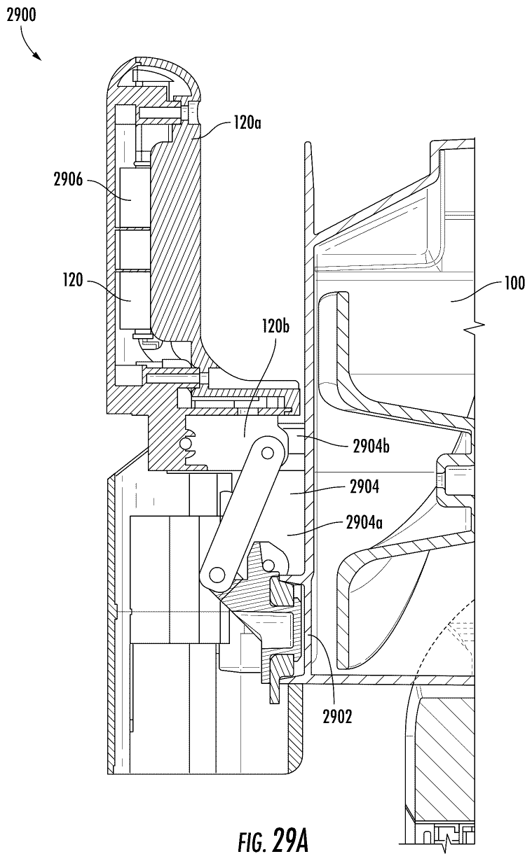

Referring now to FIG. 28, shown is a method 2800 of using pour-in opening 106 for drink maker 100, according to some non-limiting embodiments or aspects.

As shown in FIG. 28, method 2800 may optionally include, at step 2802, opening cover 160 of drink maker 100 to provide access to pour-in opening 106.

As shown in FIG. 28, method 2800 may include, at step 2804, introducing one or more liquid ingredients to mixing vessel 104 of drink maker 100 via pour-in opening 106. The one or more liquid ingredients may be added to mixing vessel 104 while mixing vessel 104 is actively mixing (e.g., while dasher 204 is rotating).

As shown in FIG. 28, method 2800 may include, at step 2806, dispensing a drink product from drink maker 100. The drink product may be dispensed while dasher 204 is rotating.

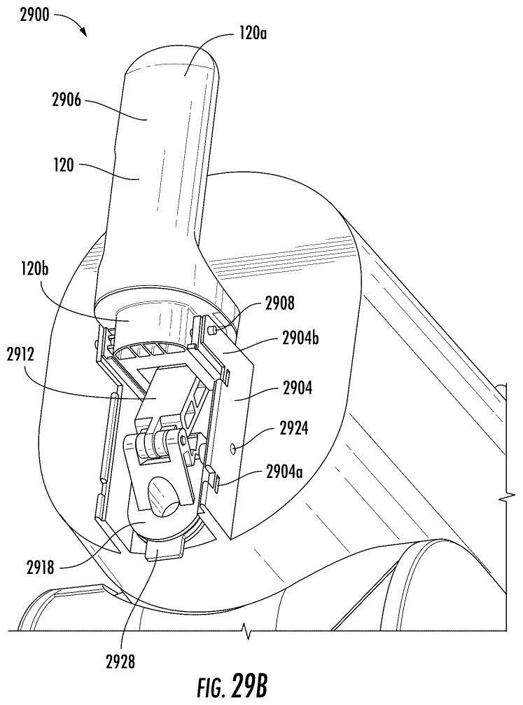

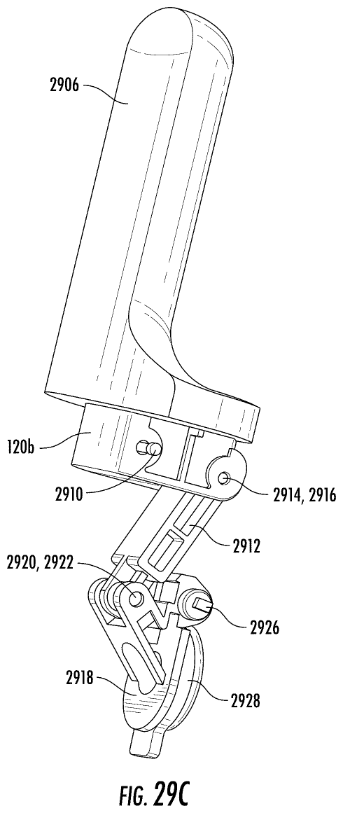

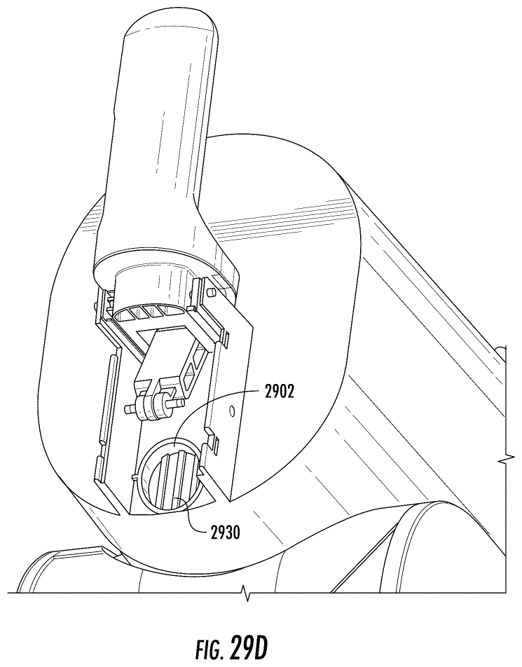

Referring now to FIGS. 29A-29D, shown is a dispenser assembly 2900 (e.g., dispenser assembly 108) for dispensing a drink product from drink maker 100, according to some non-limiting embodiments or aspects. As shown in FIG. 29A, dispenser assembly 2900 may include a dispenser housing 2904 for housing the component parts of dispenser assembly 2900. Housing 2904 may have a first portion 2904a attached to an outer surface of drink maker 100 adjacent to a spout 2902 and a second portion 2904b spaced apart from spout 2902 and extending outward from the outer surface. In some non-limiting embodiments or aspects, housing 2904 may have an inverted L-shape. In some non-limiting embodiments or aspects, other suitable shapes of housing 2904 may be employed. Handle 120 of drink maker 100 may have an upper portion 120a in the form of a user-actuatable lever 2906 and a lower portion 120b attached to second portion 2904b of housing 2904.

With further reference to FIGS. 29B and 29C, lever 2906 may be rotatable relative to second portion 2904b of housing 2904 about a first pivot member 2908. In some non-limiting embodiments or aspects, first pivot member 2908 may be a rod or pin 2910 extending through second portion 2904b of housing 2904 and lower portion 120b of handle 120. Additionally, or alternatively, other suitable types of pivot members 2908 may be employed. A link member 2912 may operatively couple to lower portion 120b of handle 120. In some non-limiting embodiments or aspects, link member 2912 may be insertable into lower portion 120b of handle 120. Link member 2912 may be rotatable relative to lever 2906 about a second pivot member 2914. In some non-limiting embodiments or aspects, second pivot member 2914 may be a rod or pin 2916 extending through link member 2912 and through lower portion 120b of handle 120. Additionally, or alternatively, other suitable types of pivot members 2914 may be employed.

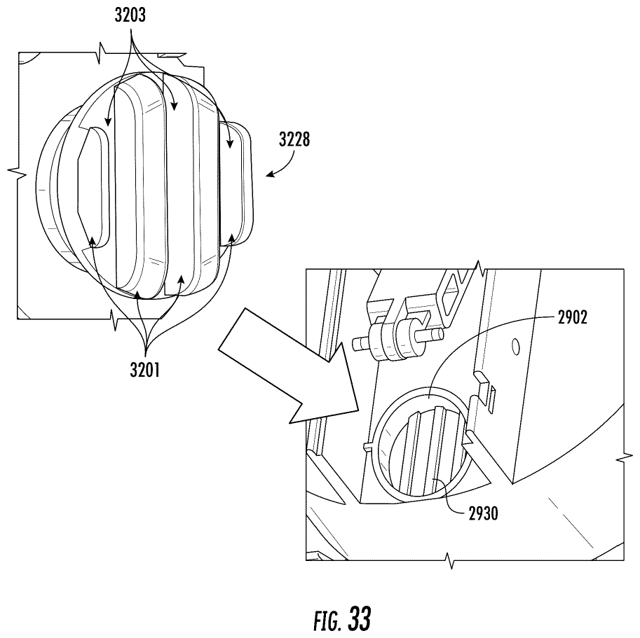

In some non-limiting embodiments or aspects, a bracket member 2918 may operatively couple to link member 2912 and may be attached to first portion 2904a of housing 2904. In some non-limiting embodiments or aspects, link member 2912 may be insertable into a portion of bracket member 2918. Bracket member 2918 may be rotatable relative to link member 2912 about a third pivot member 2920. In some non-limiting embodiments or aspects, third pivot member 2920 may be a rod or pin 2922 extending through bracket member 2918 and link member 2912. Additionally, or alternatively, other suitable types of pivot members 2920 may be employed. Bracket member 2918 may also be rotatable relative to first portion 2904a of housing 2904 about a fourth pivot member 2924. In some non-limiting embodiments or aspects, fourth pivot member 2924 may be a rod or pin 2926 extending through first portion 2904a of housing 2904 and bracket member 2918. Additionally, or alternatively, other suitable types of pivot members 2924 may be employed. A seal 2928 may attach to bracket member 2918. Seal 2928 may be configured to seal spout 2902 to prevent inadvertent dispensing of the drink product. In some non-limiting embodiments or aspects, seal 2928 may be a lip seal that covers spout 2902. Additionally, or alternatively, other suitable types of seals 2928 may be employed (see, e.g., FIG. 32). For example, in some non-limiting embodiments or aspects, seal 2928 may be, or may include, a plug that is made out of one or more relatively dense materials having a relatively high durometer and that extends into spout 2902 to seal spout 2902. Spout 2902 may include a safety grate 2930 or other mechanism to prevent the user from inadvertently inserting his or her fingers into spout 2902 (see FIG. 29D).

In some non-limiting embodiments or aspects, to dispense the drink product, actuation of lever 2906 by the user may cause link member 2912 to move upward relative to housing 2904. Because bracket member 2918 may be attached to both link member 2912 and to housing 2904, a portion of bracket member 2918 may move upward with link member 2912 while the remainder of bracket member 2918 is forced to pivot about fourth pivot member 2924. This, in turn, may cause seal 2928 to move into an open position. When seal 2928 moves into the open position, seal 2928 may uncover spout 2902 to dispense the drink product. Advantageously, in the open position, seal 2928 may be angled at about 45-60 degrees with respect to spout 2902 to direct the drink product downward toward the beverage cup. Release of lever 2906 by the user may allow the components to return to their unactuated position, allowing seal 2928 to again close the spout 2902.

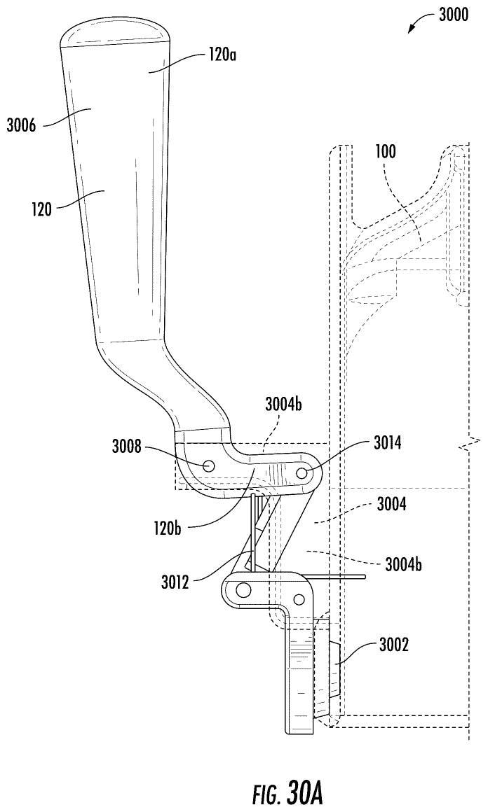

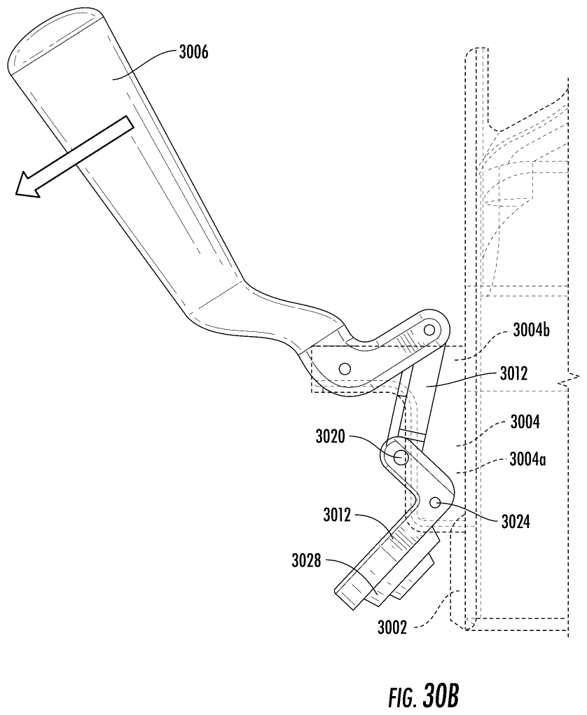

Referring now to FIGS. 30A and 30B, shown is a dispenser assembly 3000 for dispensing a drink product from drink maker 100, according to some non-limiting embodiments or aspects. Dispenser assembly 3000 may be substantially similar to dispenser assembly 2900. For example, as shown in FIG. 30A, dispenser assembly 3000 may include a dispenser housing 3004 for housing the component parts of dispenser assembly 3000. Housing 3004 may have a first portion 3004a attached to an outer surface of drink maker 100 adjacent to a spout 3002 and a second portion 3004b spaced apart from spout 3002 and extending outward from the outer surface. Handle 120 may have an upper portion 120a in the form of a user-actuatable lever 3006 and a lower portion 120b attached to second portion 3004b of housing 3004. Lever 3006 may be rotatable relative to second portion 3004b of housing 3004 about a first pivot member 3008. A link member 3012 may operatively couple to lower portion 120b of handle 120. Link member 3012 may be rotatable relative to lever 3006 about a second pivot member 3014.

With specific reference to FIG. 30B, a bracket member 3018 may operatively couple to link member 3012 and may be attached to first portion 3004a of housing 3004. In some non-limiting embodiments or aspects, bracket member 3018 may have an inverted L-shape, as shown. Additionally, or alternatively, other suitable shapes of bracket member 3018 may be employed. Bracket member 3018 may be rotatable relative to link member 3012 about a third pivot member 3020. Bracket member 3018 may also be rotatable relative to first portion 3004a of housing 3004 about a fourth pivot member 3024. A seal 3028 may attach to bracket member 3018. Seal 3028 may be configured to seal spout 3002 in a closed position. In some non-limiting embodiments or aspects, seal 3028 may be a lip seal that covers spout 3002. Additionally, or alternatively, seal 3028 may be, or may include, a plug that is made out of one or more relatively dense materials having a relatively high durometer and that extends into spout 3002 to seal spout 3002.

In some non-limiting embodiments or aspects, to dispense the drink product, actuation of lever 3006 by the user may cause link member 3012 to move upward relative to housing 3004. Because bracket member 3018 may be attached to both link member 3012 and to housing 3004, a portion of bracket member 3018 may move upward with link member 3012 while the remainder of bracket member 3018 is forced to pivot about fourth pivot member 3024. This, in turn, may cause seal 3028 to move into an open position. When seal 3028 moves into the open position, seal 3028 may uncover spout 3002 to dispense the drink product. Advantageously, in the open position, seal 3028 may be angled at about 45-60 degrees with respect to spout 3002 to direct the drink product downward toward the beverage cup. Release of lever 3006 by the user may allow the components to return to their unactuated position, allowing seal 3028 to again close spout 3002.

Advantageously, unlike other dispenser mechanisms, dispensing assemblies 2900, 3000 of this disclosure do not rely on leverage against the outer surface of drink maker 100 to open seal 2928, 3028. This may reduce wear and tear of the component parts of dispenser assembly 2900, 3000 and on the outer surface of drink maker 100. Furthermore, because seal 2928, 3028 moves both horizontally and vertically with respect to spout 2902, 3002 to unseal spout 2902, 3002, the open position of seal 2928, 3028 may provide less obstruction to the flow of the drink product from spout 2902, 3002.

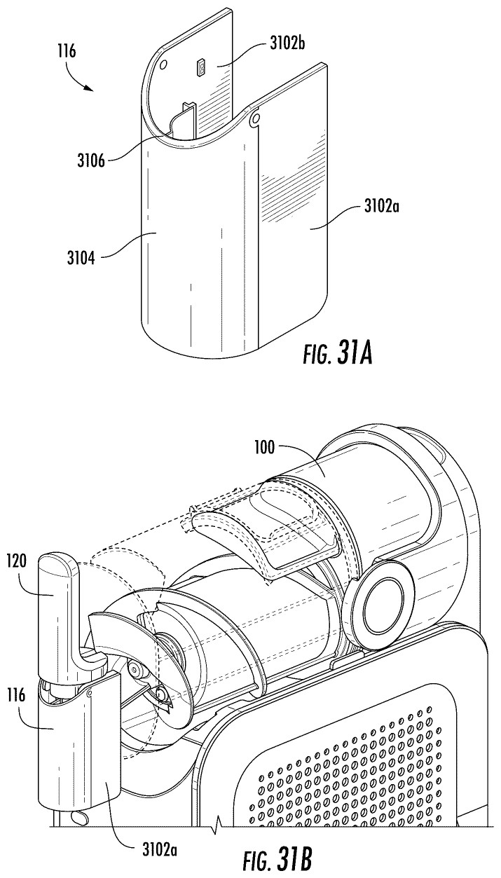

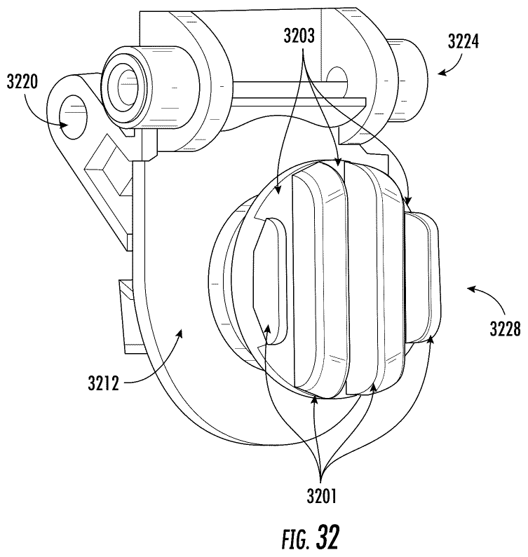

Referring now to FIGS. 31A and 31B, shown is a greater detail of a spout cover or shroud 116 for covering a portion of dispenser assembly 2900, 3000, according to some non-limiting embodiments or aspects. As shown in FIG. 31A, shroud 116 may include a first panel section 3102a and a second panel section 3102b extending substantially parallel to one another. A front section 3104 may extend between the panel sections 3102a, 3102b. In some non-limiting embodiments or aspects, panel sections 3102a, 3102b may be substantially flat, while front section 3104 may be curved, as shown. In some non-limiting embodiments or aspects, front section 3104 may include an arcuate upper edge 3106 configured such that actuation of handle 120 is not impeded. Additionally, or alternatively, other suitable shapes of upper edge 3106, such as the rectilinear shape shown in FIG. 1, may be employed. As shown in FIG. 31B, panel sections 3102a, 3102b may be configured to form a removable snap fit with dispenser housing 2904, 3004. A length of shroud 116 may be selected to cover the component parts of dispensing assemblies 2900, 3000 other than handle 120 to improve the aesthetic appearance of drink maker 100 and encourage proper drink product flow. Shroud 116 may also aid in directing the drink product downward toward the beverage cup. Shroud 116 may be made of a dishwasher safe material for easy cleaning.

In some non-limiting embodiments or aspects, at least front section 3104 of shroud 116 may be vertically moveable relative to dispenser assembly 2900, 3000. For example, front section 3104 may be moveable relative to first panel section 3102a and second panel section 3102b. In some non-limiting embodiments or aspects, front section 3104 may be hingedly connected to first and second panel sections 3102a, 3102b or may be vertically slidable relative first and second panel sections 3102a, 3102b. Such movement may be useful when dispensing a non-frozen and/or low viscosity liquid, to prevent the beverage from dispensing at too lateral of a trajectory from spout 2902, 3002. Such a lateral trajectory may result in at least a portion of the beverage not dispensing into a receiving vessel located below spout 2902, 3002.

It should be appreciated that the various implementations described herein are not limited to making frozen or semi-frozen drinks, but may be applied to produce a cold and/or cooled drink product that is cooler than a received drink product, but not frozen or semi-frozen. For example, in some implementations, the same or similar mechanisms and/or techniques may be used as part of a cold drink machine and/or cooled drink maker to produce, maintain and dispense cold drinks.

Referring now to FIG. 32, shown is a lower portion 3200 of a dispenser assembly (e.g. dispenser assembly 2900, 3000) for dispensing a drink product from drink maker 100, according to some non-limiting embodiments or aspects. Lower portion 3200 may include a seal 3228 that may attach to a bracket member 3212. Seal 3228 may be configured to seal a spout (e.g., spout 2902, 3002) of mixing vessel 104 in a closed position. In some non-limiting embodiments or aspects, seal 3228 may partly include a lip seal that covers the spout. Additionally, or alternatively, seal 3228 may include a plurality of protruding members 3201 configured to at least partially extend into the spout when seal 3228 is in the closed position. For the purpose of illustration, as shown in FIG. 32, the plurality of protruding members 3201 may be oblong in shape, such as having a form that is longer in a first (e.g., vertical) direction. In some non-limiting embodiments or aspects, the plurality of protruding members 3201 may be uniform in shape, symmetrical in configuration, uniquely shaped, or any combination thereof. In some non-limiting embodiments or aspects, the plurality of protruding members 3201 may be shaped as cylinders, rounded rectangular prisms, ribs, ridges, and/or the like. In some non-limiting embodiments or aspects, the shape of the plurality of protruding members 3201 may be selected to be complimentary to one or more geometries of the spout (see, e.g., FIG. 33).

In some non-limiting embodiments or aspects, the plurality of protruding members 3201 may extend at least partially into the spout, e.g., to force drink product back into mixing vessel 104, where dasher 204 (and the movement of drink product caused thereby) may urge the drink product back into the stirred mixture. Furthermore, by extending at least partially into the spout, the plurality of protruding members 3201 may physically contact and force clogged drink product (e.g., formed at least partly of ice) out of the spout and back into mixing vessel 104, using the return biasing force of the dispenser assembly (e.g., dispenser assembly 2900, 3000). Moreover, by immediately removing residual drink product from the spout after pouring the drink product (using plurality of protruding members 3201), little-to-no drink product may be caught in the spout, preventing the drink product from further freezing or clogging the spout.

In some non-limiting embodiments or aspects, seal 3228 may further include a plurality of recesses 3203 formed at least partly by plurality of protruding members 3201. For example, FIG. 32 depicts four protruding members 3201 defining three recesses 3203 therebetween. It will be appreciated that the number of protruding members 3201 may vary, and the number of recesses 3203 may vary therewith. In some non-limiting embodiments or aspects, the plurality of recesses 3203 may include a plurality of channels defined on each side by a protruding member of the plurality of protruding members 3201. It will be appreciated that the plurality of recesses 3203 may have other geometries defined by the negative space surrounding plurality of protruding members 3201. The shape of the plurality of recesses 3203 may be selected to be complimentary to one or more geometries of the spout (see, e.g., FIG. 33). For example, the geometry of the plurality of recesses 3203 may correspond to a geometry of a grate (e.g., grate 2930) associated with the spout such that the negative space of plurality of recesses 3203 may receive the grate.

In some non-limiting embodiments or aspects, seal 3228 may be supported by bracket member 3212 connected to a fourth pivot member 3224 (e.g., fourth pivot member 2924) and a third pivot member 3220 (e.g., third pivot member 2920). This may allow seal 3228 to be rotatable about fourth pivot member 3224 and/or third pivot member 3220. See FIGS. 29A-29D for further elements of a dispenser assembly (e.g., dispenser assembly 2900) on which lower portion 3200 may be formed.

In some non-limiting embodiments or aspects, the plurality of protruding members 3201 may be formed on a surface of seal 3228. In some non-limiting embodiments or aspects, the plurality of protruding members 3201 may be formed coextensively with seal 3228 as a unitary body. However configured relative to seal 3228, the plurality of protruding members 3201 may be formed of a same or similar material to seal 3228, such as a relatively dense material having a relatively high durometer. The material of the plurality of protruding members 3201 may be selected such that the plurality of protruding members 3201 may be slightly flexible but retain their default shape, e.g., so that the plurality of protruding members 3201 may safely and repeatedly insert at least partially into the spout.

Referring now to FIG. 33, shown is lower portion 3200 of a dispenser assembly (e.g., dispenser assembly 2900, 3000) for dispensing a drink product from drink maker 100, adjacent a spout (e.g., spout 2902) of mixing vessel 104, according to some non-limiting embodiments or aspects. As shown, the plurality of protruding members 3201 may be configured to correspond to openings in spout 2902, particularly openings in grate 2930. The plurality of recesses 3203 may also be configured to correspond to partial coverings in spout 2902, particularly the bars of grate 2930. For example, each protruding member of plurality of protruding members 3201 may correspond to an opening in spout 2902 (e.g., an opening in grate 2930) and extend at least partially therein. By way of further example, each recess of plurality of recesses 3203 may correspond to a covering in spout 2902 (e.g., a bar in grate 2930), and by the negative space created by the recess, the covering in spout 2902 may be at least partially received against seal 3228 and/or within the recess.

In some non-limiting embodiments or aspects, and as shown in FIG. 32, the plurality of protruding members 3201 may be oblong in shape, corresponding to oblong openings in grate 2930. When seal 3228 is in the closed position, each protruding member of plurality of protruding members 3201 may extend at least partially into spout 2902, including in the openings of grate 2930. Similarly, plurality of recesses 3203 may be oblong in shape, corresponding to oblong bars in grate 2930. When seal 3228 is in the closed position, each recess of plurality of recesses 3203 may receive, against seal 3228 and/or within the recess, a bar of grate 2930. It will be appreciated that other geometries of plurality of protruding members 3201 and plurality of recesses 3203 may be selected based on the geometry of spout 2902 and/or grate 2930. For example, if grate 2930 is a hatched pattern, each protruding member of plurality of protruding members 3201 may be shaped to correspond to a hole in grate 2930, and plurality of recesses 3203 may have a corresponding hatched pattern to receive grate 2930 therein. See FIGS. 29A-29D for further description of spout 2902 and grate 2930.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect may be combined with one or more features of any other embodiment or aspect.

What is claimed is:

1. A drink maker comprising:
a mixing vessel configured to contain a drink product;
a spout comprising an opening in the mixing vessel;
a grate configured to at least partly cover the spout; and
a dispenser assembly comprising:
a seal configured to close a flow from the spout in a closed position and open the flow from the spout in an open position; and
a plurality of protruding members extending from the seal, the plurality of protruding members at least partially extending into the spout through the grate when the seal is in a closed position.

2. The drink maker of claim 1, wherein the seal and the plurality of protruding members are formed coextensively from a same material.

3. The drink maker of claim 1, wherein the plurality of protruding members are attached to a surface of the seal facing the spout.

4. The drink maker of claim 1, wherein the plurality of protruding members define a plurality of recesses comprising at least one negative space adjacent the plurality of protruding members.

5. The drink maker of claim 4, wherein a geometry of the plurality of recesses corresponds to a geometry of the grate.

6. The drink maker of claim 5, wherein the grate is at least partially received in the plurality of recesses when the seal is in the closed position.

7. The drink maker of claim 1, wherein each protruding member of the plurality of protruding members is oblong in shape.

8. The drink maker of claim 7, wherein the grate comprises a plurality of openings that are oblong in shape.

9. The drink maker of claim 8, wherein the plurality of protruding members at least partially extend into the openings of the grate when the seal is in the closed position.

10. The drink maker of claim 9, wherein the plurality of protruding members comprise at least four protruding members, wherein the openings of the grate comprise at least four openings, and wherein each protruding member of the plurality of protruding members corresponds to an opening of the grate.

11. A dispenser assembly for a drink maker, the dispenser assembly comprising:
a seal configured to close a flow from a spout of the drink maker in a closed position and open the flow from the spout in an open position, the spout comprising an opening in a mixing vessel of the drink maker that is configured to contain a drink product; and
a plurality of protruding members extending from the seal, the plurality of protruding members at least partially extending into the spout through a grate of the drink maker when the seal is in a closed position, the grate configured to at least partly cover the spout.

12. The dispenser assembly of claim 11, wherein the seal and the plurality of protruding members are formed coextensively from a same material.

13. The dispenser assembly of claim 11, wherein the plurality of protruding members are attached to a surface of the seal facing the spout.

14. The dispenser assembly of claim 11, wherein the plurality of protruding members define a plurality of recesses comprising at least one negative space adjacent the plurality of protruding members.

15. The dispenser assembly of claim 14, wherein a geometry of the plurality of recesses corresponds to a geometry of the grate.

16. The dispenser assembly of claim 15, wherein the grate is at least partially received in the plurality of recesses when the seal is in the closed position.

17. The dispenser assembly of claim 11, wherein each protruding member of the plurality of protruding members is oblong in shape.

18. The dispenser assembly of claim 17, wherein the plurality of protruding members at least partially extend into oblong openings of the grate when the seal is in the closed position.

19. The dispenser assembly of claim 18, wherein the plurality of protruding members comprise at least four protruding members.

20. The dispenser assembly of claim 19, wherein each protruding member of the plurality of protruding members corresponds to an opening of the grate.
